(19) United States
(12) Patent Application Publication
(10) Pub. No.: US 2017/0238575 A1
(43) Pub. Date: Aug. 24, 2017

(54) Edible compositions and methods

(71) Applicants: Joseph M. BAWOL, Bealeton, VA (US); Marilyn P. BAWOL, Bealeton, VA (US)

(72) Inventors: Joseph M. BAWOL, Bealeton, VA (US); Marilyn P. BAWOL, Bealeton, VA (US)

(21) Appl. No.: 14/998,794

(22) Filed: Feb. 18, 2016

(51) Int. Cl. A23G 3/34; A23G 3/48; A23G 3/42

(52) U.S. Cl. CPC A23G 3/343; A23G 3/42; A23G 3/48; A23V 2002/00

(57) ABSTRACT

An edible composition includes thickening agent, sweetener, humectant, water, and preservative. The edible composition may be used to form edible paints, fabrics, papers, clothes, decorative articles, or any other edible product. The edible composition may remain flexible and/or stretchy after drying.

### BACKGROUND

Field

The present disclosure relates to edible compositions used to decorate cakes, pastries, cookies, and other foods, and/or to protect, and/or to seal fresh foods.

Description of Related Art

Food products may be decorated with printed edible sheet materials, fondant, sugar sculptures, and the like.

Edible decorations and other articles may be formed of sugar, isomalt, fondant, pastillage, and/or gum paste. These decorations and other articles may crack and/or break when dried.

### SUMMARY

At least one example embodiment relates to edible compositions.

In at least one example embodiment, an edible composition comprises: a thickening agent in an amount ranging from about 8% by weight based on a weight of the edible composition to about 35% by weight based on the weight of the edible composition; a sweetener in an amount ranging from about 1% by weight based on the weight of the edible composition to about 9% by weight based on the weight of the edible composition; a humectant in an amount ranging from about 10% by weight based on the weight of the edible composition to about 75% by weight based on the weight of the edible composition; and a preservative in an amount ranging from about 0% by weight based on the weight of the edible composition to about 0.1% by weight based on the weight of the edible composition.

In at least one example embodiment, the composition may also include water in an amount ranging from about 30% by weight based on the weight of the edible composition to about 65% by weight based on the weight of the edible composition.

In at least one example embodiment, the thickening agent comprises at least one of gelatin, agar agar, or collagen hydrosolate.

In at least one example embodiment, the sweetener is an artificial sweetener. In at least one example embodiment, the artificial sweetener comprises at least one of stevia leaf extract, saccharin, aspartame, sucralose, xylitol, inulin, dextrose, isomalt, maltodextrin, acesulfame potassium, mogrosides, or erythritol. In at least one example embodiment, the sweetener comprises sucrose. In at least one example embodiment, the sweetener comprises at least one of corn syrup, maple syrup, light, dark or high fructose corn syrup, glucose syrup, agave nectar, or honey.

In at least one example embodiment, the humectant comprises at least one of vegetable based glycerin, animal based glycerin, or synthetic glycerin.

In at least one example embodiment, the preservative comprises at least one of potassium sorbate or citric acid.

In at least one example embodiment, the composition may include an additive. In at least one example embodiment, the additive comprises one or more of flavorants, colorants, or aromatics.

In at least one example embodiment, the edible composition has a shelf life of at least about 1 month. The shelf life may range from about 1 month to about 1 year.

In at least one example embodiment, the edible composition has an elongation at break of up to about 275%. In at least one example embodiment, the edible composition has a tensile strength ranging from about 0.001 psi to about 0.01 psi.

At least one example embodiment relates to edible decorative articles.

In at least one example embodiment, an edible decorative article, comprises: an edible composition including, a thickening agent in an amount ranging from about 8% by weight based on the weight of the edible composition to about 35% by weight based on the weight of the edible composition, a sweetener in an amount ranging from about 1% by weight based on the weight of the edible composition to about 9% by weight based on the weight of the edible composition, a humectant in an amount ranging from about 10% by weight based on the weight of the edible composition to about 75% by weight based on the weight of the edible composition, a preservative in an amount ranging from about 0% by weight based on the weight of the edible composition to about 0.1% by weight based on the weight of the edible composition, water in an amount ranging from about 30% by weight based on the weight of the edible composition to about 65% by weight based on the weight of the edible composition, and at least one additive.

In at least one example embodiment, the thickening agent comprises at least one of gelatin, agar agar, or collagen hydrosolate.

In at least one example embodiment, the sweetener is an artificial sweetener. The artificial sweetener may comprise at least one of stevia leaf extract, saccharin, aspartame, sucralose, xylitol, inulin, dextrose, isomalt, maltodextrin, acesulfame potassium, mogrosides, or erythritol. The sweetener may comprises at least one of corn syrup, maple syrup, light, dark or high fructose corn syrup, glucose syrup, agave nectar, or honey.

In at least one example embodiment, the humectant comprises at least one of vegetable based glycerin, animal based glycerin, or synthetic glycerin.

In at least one example embodiment, the preservative comprises at least one of potassium sorbate or citric acid.

In at least one example embodiment, the additive comprises one or more of flavorants, colorants, or aromatics.

In at least one example embodiment, the edible, decorative article has a shelf life of at least about 1 month.

In at least one example embodiment, the edible decorative article includes, at least one of a sheet, a fabric, a body paint, a glue, a sealant, a molded shape, a cut-out shape, a woven article, edible clothing, a sculpture, a printed sheet, or piped shapes.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The patent or application file contains at least one photograph executed in color. Copies of this patent or patent application publication with color photograph(s) will be provided by the Office upon request and payment of the necessary fee.

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIGS. 1A and 1B are illustrations of a kit including ingredients of an edible composition according to at least one example embodiment.

FIGS. 2A and 2B are illustrations of an edible composition in liquid form according to at least one example embodiment.

FIG. 3 is an illustration of an edible composition in gel form according to at least one example embodiment.

FIGS. 4A, 4B, 4C, and 4D are illustrations of an edible composition being spread on a flat surface according to at least one example embodiment.

FIG. 5 is an illustration of a sheet of an edible composition according to at least one example embodiment.

FIG. 6 is an illustration of a printed sheet of an edible composition according to at least one example embodiment.

FIG. 7 is an illustration of an edible composition being piped according to at least one example embodiment.

FIGS. 8A and 8B are illustrations of an edible composition applied to fresh fruit as a sealant according to at least one example embodiment.

FIGS. 9A, 9R, 9C, 9D, 9E, and 9F are illustrations of an edible fabric formed from an edible composition according to at least one example embodiment.

FIGS. 10A and 10B are illustrations of an edible composition used as body paint according to at least one example embodiment.

FIGS. 11A, 11B, 11C, 11D, 11E, and 11F are illustrations of bows formed of an edible fabric according to at least one example embodiment.

FIGS. 12A, 12B, and 12C are illustrations of an edible composition applied to wafer paper according to at least one example embodiment.

FIGS. 13A, 13B, 13C, and 13D are illustration of strips being cut and woven to form an edible fabric.

FIGS. 14A, 14B, and 14C are illustrations of printed edible sheets according to at least one example embodiment.

FIGS. 15A, 15B, and 15C are illustrations of a molded decoration formed of an edible composition according to at least one example embodiment.

FIGS. 16A, 16B, 16C, 16D, 16E, 16F, 16G, and 16H are illustrations of shapes cut out of an edible sheet according to at least one example embodiment.

FIGS. 17A, 17B, and 17C are illustrations of edible lace formed of an edible composition according to at least one example embodiment.

FIGS. 18A, 18B, 18C, and 18D is an illustration of an edible rose formed from the edible composition according to at least one example embodiment.

FIGS. 19A and 19B are illustrations of dresses formed of an edible composition according to at least one example embodiment.

FIG. 20 is an illustration of an edible bag and prosthetic formed of an edible composition according to at least one example embodiment.

FIG. 21 is an illustration of a fringe formed of strips formed from an edible composition according to at least one example embodiment.

FIGS. 22A and 22B are illustrations of an edible composition being mixed with luster dust according to al least one example embodiment.

FIGS. 23A and 23B are illustrations of strips of edible sheets being glued together to form larger sheets according to at least one example embodiment.

FIGS. 24A and 24B are illustrations of colorant being added to an edible composition to form a colored edible composition according to at least one example embodiment.

FIGS. 25A, 25B, 25C, and 25D are illustrations of the colored edible composition of FIGS. 24A and 24B being spread on a textured mold and/or surface to form a textured edible material according to at least one example embodiment.

FIGS. 26A, 26B, and 26C are illustrations of an edible composition being used as an edible paint according to at least one example embodiment.

FIGS. 27A, 27B, and 27C are illustrations of sculptures formed from a combination of an edible composition and one or more of fondant or gum paste according to at least one example embodiment.

FIG. 28 is an illustration of a pre-mixed edible composition according to at least one example embodiment.

FIGS. 29A and 29B are illustrations of an edible fabric being formed into an edible skirt and including an edible composition acting as an adhesive according to at least one example embodiment.

FIGS. 30A and 30B are illustrations of an edible fabric being formed into a chef's hat using an edible composition as an adhesive according to at least one example embodiment.

FIGS. 31A and 31B are illustrations of an edible fabric being molded around an object to form an edible replica of the object akin to an edible paper maché according to at least one example embodiment.

FIG. 32 is an illustration of an edible hat made from an edible composition according to at least one example embodiment.

FIG. 33 is an illustration of an edible valentine made from an edible composition according to at least one example embodiment.

FIG. 34 is an illustration of an edible valentine made from an edible composition according to at least one example embodiment.

FIG. 35 is an illustration of an edible gift bow made from an edible composition according to at least one example embodiment.

FIG. 36 is an illustration of an edible sculpture made from an edible composition according to at least one example embodiment.

FIG. 37 is an illustration of an edible lily made from an edible composition according to at least one example embodiment.

FIG. 38 is an illustration of edible shoelaces made from an edible composition according to at least one example embodiment.

FIG. 39 is an illustration of edible ribbon roses made from an edible composition according to at least one example embodiment.

FIGS. 40A, 40B, 40C, and 40D are illustrations of edible embroidery made from an edible composition according to at least one example embodiment.

FIG. 41 is an illustration of edible ship sails made from an edible composition according to at least one example embodiment.

FIGS. 42A, 42B, 42C, and 42D are illustrations of a mold being formed of an edible composition according to at least one example embodiment.

FIGS. 43A, 43B, 43C, 43D, and 43E are illustrations of a mold being formed of an edible composition according to at least one example embodiment.

FIG. 44 is an illustration of an edible shoe according to at least one example embodiment.

### DETAILED DESCRIPTION OF EXAMPLE EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms HS well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

In at least one example embodiment, an edible composition can be used to form edible decorations, paint, and/or glue, and/or used as a sealant to maintain freshness of foods.

In at least one example embodiment, the edible composition includes thickening agent, sweetener, humectant, preservative, and water. In at least one example embodiment, the thickening agent may be added in an amount ranging from about 8% by weight based on the weight of the edible composition to about 35% by weight based on the weight of the edible composition (e.g., about 10% to about 30%, about 15% to about 25% or about 18% to about 22%). In at least one example embodiment, the sweetener may be added in an amount ranging from about 1% by weight based on the weight of the edible composition to about 9% by weight based on the weight of the edible composition (e.g., about 2% to about 8%, about 3% to about 7%, or about 4% to about 6%). In at least one example embodiment, the humectant may be added in an amount ranging from about 10% by weight based on the weight of the edible composition to about 75% by weight based on the weight of the edible composition (e.g., about 15% to about 70%, about 20% to about 65%, about 25% to about 60%, about 30% to about 55%, or about 35% to about 50%). In at least one example embodiment, the preservative may be added in an amount ranging from about 0% by weight based on the weight of the edible composition to about 0.1% by weight based on the weight of the edible composition (e.g. about 0.001% to about 0.05%). In at least one example embodiment, water may be added in an amount ranging from about 30% by weight based on the weight of the edible composition to about 65% by weight based on the weight of the edible composition (e.g., about 35% to about 60%, about 40% to about 55%, or about 45% to about 50%).

In at least one example embodiment, the edible composition may form a base edible composition, an edible glue, an edible lace composition, or any combination of these. Any of the edible compositions may be further be combined with fondant, gum paste, pastillage, chocolate, white chocolate, marshmallow, at least partially liquefied hard candies, waxes, sugar paste, icing, isomalt, marzipan, chocolate based candies, and/or any other edible material to form additional edible compositions. Moreover, other edibles may be embedded in the edible composition. For example, candies, nuts, fruits, herbs, meats, vegetables, sprinkles, and/or any other edible substance may be embedded in the edible composition. The edible compositions may remain flexible and/or pliable and should not crack and/or break during forming of edible articles and/or during use and/or shipping of the edible articles.

In at least one example embodiment, once the ingredients are combined, the edible compositions can be molded, spread on surfaces to form edible fabrics and/or sheets, painted, piped onto surfaces of foods, such as cakes, cut, pulled, stretched, sculpted, stenciled, and/or otherwise manipulated to form decorations for food products and/or any other edible articles.

In at least one example embodiment, the thickening agent may include at least one of gelatin, agar agar, or collagen hydrosolate. Agar agar may be used to form an edible composition that may be free of animal products and may be suitable for ingestion by vegans.

In at least one example embodiment, the gelatin may be pork or beef gelatin. However, any type of gelatin may be suitable for inclusion in the edible composition. The gelatin may have a bloom ranging from about 50 g to about 300 g (e.g., about 100 g to about 250 g or about 150 g to about 200 g) and a viscosity ranging from about 15 to about 75 (e.g., about 20 to about 70, about 25 to about 65, about 30 to about 60, about 35 to about 55, or about 40 to about 50). In at least one example embodiment, the gelatin acts as a stabilizer, thickening agent, and/or texturizing agent. The gelatin may have a pH ranging from about 4 to about 7 (e.g., about 5 to about 6).

In at least one example embodiment, the sweetener may be sugar or an artificial sweetener. Suitable artificial sweeteners may include at least one of stevia leaf extract, saccharin, aspartame, sucralose, xylitol, inulin, dextrose, isomalt, maltodextrin, rebiamia, acesulfame potassium, mogrosides, neotame, maltitol, sorbitol, mannitol or erythritol. The sweetener may include sucrose. In at least one example embodiment, the sweetener may include light, dark or high fructose corn syrup, maple syrup, glucose syrup, honey, or agave nectar. Any suitable sweetener may be added in lieu of or in addition to the a hove-named sweeteners, such as cyclamate, and acesulfame potassium. For example, TRUVIA®, SPLENDA®, ALL NATURAL STEVIA®, EQUAL®, STEVIA IN THE RAW®, SWEET & LOW, ZING™, and SWEET LEAF STEVIA®, SUNETT, SWEET ONE, NUTRASWEET®, PURE VIA, or any flavored syrups may be used as the sweetener in the edible composition. The amount of sweetener may be varied based on the sweetness by weight, which varies based on the sweetener.

In at least one example embodiment, the humectant may include glycerin, triacetin, glycerin triacetate, vegetable oil, and/or corn oil. The glycerin may include vegetable glycerin, which may include palm oil, palm stearin, palm kernel oil, coconut oil, and/or soybean oil. The glycerin may be animal glycerin, which may be a natural byproduct of animal fats, such as beef tallow. The glycerin may be synthetic glycerin produced from cane or corn syrup sugar or propylene.

In at least one example embodiment, the glycerin may be vegetable-based glycerin or animal-based glycerin. Vegetable-based glycerin may be used to form the edible composition having no animal products therein. In at least one example embodiment, sugar may be substituted for the glycerin by using about ¼ cup of sugar for each tablespoon of glycerin used in the edible composition. Both animal-based and synthetic glycerin can be used in the same amounts as vegetable glycerin in recipes and will have the same effect in the recipe.

In at least one example embodiment, the preservative may include one or more of potassium sorbate or citric acid. In other example embodiments, the preservative may include any tribasic acid, such as sodium citrate in lieu of citric acid. In lieu of potassium sorbate, the preservative may include one or more of benzoic acid, benzoate, sulphur dioxide, sulphite compounds, sulfites, natamycin, nitrite compounds, nitrate compounds, hydroxybenzoic acid, propionic acid, sodium propionate, sorbic acid, sodium sorbate, rosemary extract, or calcium propionate.

In at least one example embodiment, the edible compositions may also include an additive. Suitable additives may include flavorants, colorants, and/or aromatic compositions. In at least one example embodiment, the additive may be added in an amount ranging from about 1% by weight based on the weight of the edible composition to about 45% by weight based on the weight of the edible composition (e.g., about 5% to about 10%, about 10% to about 35%, about 15% to about 30%, or about 20% to about 25%). The amount of flavorant, colorant, and/or aromatic composition added to the edible compositions may vary depending on the relative strength of the flavor, color and/or smell and the desired final flavor, color, and/or smell.

Suitable flavorants include any vegetable, herb, meat, food, candy, alcohol, drink, or other flavorant. The flavorants may be oil-based or water-based. For example, the flavorant may include vanilla, caramel, chocolate, cinnamon, butter, rum, apple, peppermint, almond, anise, banana, cherry, coconut, coffee, lemon, maple, orange, raspberry, strawberry, blueberry, and/or any other suitable flavor. In at least one example embodiment, the flavorant may include only natural and organic ingredients.

In at least one example embodiment, the colorant may be added in an amount sufficient to form an edible composition having a desired color. The colorant may be a glow-in-the-dark colorant. The colorant may be food-safe. The colorant may include luster dust, pearl dust, petal dust, sparkle dust, and/or edible glitter dust for baking in any suitable color, and may be applied during mixing of the ingredients of the edible composition or after the edible composition has been made and formed into a final edible product.

In at least one example embodiment, the aromatic composition may be any edible substance that imparts a desired aroma including oils, flavorants, botanical materials, and the like.

In at least one example embodiment, the water may be tap water, distilled water, deionized water, purified water, filtered water, unfiltered water, carbonated water, uncarbonated water, and/or flavored water. Instead of, or in addition to water, juices, milk, sodas, and/or any other drink may be substituted for the water. If juices and/or sodas are used, natural and/or artificial sweeteners in the juices and/or sodas may take the place of at least a portion of the additive and/or sweetener.

In at least one example embodiment, the water and glycerin may be in liquid form, while the thickening agent, die sweetener, and the preservative may be in powder and/or solid form.

In at least one example embodiment, to form the edible composition, the dry ingredients are added to water and mixed rapidly and thoroughly. The dry ingredients may dissolve more quickly in warmer water, but warmer water may slow blooming and solidification of the resulting edible composition. Thus, the water may be at any temperature. In at least one example embodiment, once water is combined with the dry ingredients, the mixture is allowed to bloom for at least about 1 hour to about 12 hours before other liquid ingredients are added. The ingredients may be mixed with any suitable instrument including a spoon, a whisk, or a mixer.

In at least one example embodiment, the dry ingredients may be combined with boiling water to remove and/or reduce lumps. Alternatively, the composition may be heated during mixing to remove lumps. For example, the composition may be heated to a temperature of up to about 160° F.

The following example are provided for illustration and do not limit the overall scope.

### Example 1

About 32 grams (g) of 225 bloom and 25 mesh beef gelatin available from Great Lakes Gelatin Company of Grayslake, Ill., is combined with 4 g SweetLeaf® Organic Choice Blend stevia leaf extract obtained from Wisdom Natural Brands, about 0.189 g powdered potassium sorbate, about 45 g of food grade glycerin, and about ½ cup water to form a first edible composition. The water may be any temperature. The composition is liquid when formed, but becomes a solid and/or a gel at room temperature.

In at least one example embodiment, the first edible composition of Example 1 has a shelf life of at least about 1 month when subjected to refrigerated shelf life testing according to Salmonella RapidCheck® AOAO 080601, Listeria RapidCheck® AOAO 920401, and E Coli Petri Film AOAC 991.4 at a temperature ranging from about 1° C. to about 4° C. Table 1, below, provides the aerobic plate count and total coliform count (e.g., colony forming units (“CFU”)) over 30 days.

TABLE 1

| | | Aerobic | Total | |
|---|---|---|---|---|
| Shelf Life | Dated | Plate Count | Coliform | Yeast and Mold |
| Study | Tested | CFU/g | CFU/mL | CFU/g |
| Day 0 | Dec. 1, 2015 | <10 | <10 | <10 yeast/ |
| | | | | <10 mold |
| Day 2 | Dec. 3, 2015 | <10 | <10 | <10 yeast/ |
| | | | | <10 mold |
| Day 7 | Dec. 8, 2015 | <10 | <10 | <10 yeast/ |
| | | | | <10 mold |
| Day 14 | Dec. 15, 2015 | <10 | <10 | <10 yeast/ |
| | | | | <10 mold |
| Day 30 | Dec. 31, 2015 | <10 | <10 | <10 yeast/ |
| | | | | <10 mold |

As shown in Table 1, the first edible composition remained stable without any microbial contamination throughout a 30-day shelf life study.

In at least one example embodiment, the first edible composition of Example 1 has a shelf life of at least about 1 month when subjected to a room temperature shelf life testing according to Salmonella RapidCheck® AOAO 080601, Listeria RapidCheck® AOAO 920401, and E Coli Petri Film AOAC 991.4 at about 68° F. Table 2, below, provides the aerobic plate count and total coliform count over 30 days when the first edible composition may be at room temperature.

TABLE 2

| | | Aerobic | Total | |
|---|---|---|---|---|
| Shelf Life | Dated | Plate Count | Coliform | Yeast and Mold |
| Study | Tested | CFU/g | CFU/mL | CFU/g |
| Day 0 | Dec. 16, 2015 | <10 | <10 | <10 yeast/ |
| | | | | <10 mold |
| Day 5 | Dec. 21, 2015 | <10 | <10 | <10 yeast/ |
| | | | | <10 mold |
| Day 14 | Dec. 30, 2015 | <10 | <10 | <10 yeast/ |
| | | | | <10 mold |
| Day 30 | Jan. 15, 2016 | <10 | <10 | <10 yeast/ |
| | | | | <10 mold |

As shown in Table 2, the first edible composition remained stable without any microbial contamination throughout a 30-day shelf life study.

While not wishing to be bound by theory, it is believed that the first edible composition has a shelf life of about 3 months to about 1 year.

To determine a tensile strength of the first edible composition, the first edible composition was thinly spread on a silicone sheet and then cut into 1-inch by 6-inch strips, each strip having a thickness ranging from about 0.0280 inch to about 0.0150 inch.

Each strip was put in a universal testing machine that conducts tension and compression style testing according to ASTM D5035-11 (2015). The test was modified to include use of sandpaper at the grips to hold each strip therein and prevent slipping. Each end of the samples were clamped in the sandpaper covered grips, and separated at a rate of 12 inches per minute. The samples were tested at about 23° C. and about 50% relative humidity.

The average maximum load at which each of the samples broke was 5 pounds (IB_{f}). The maximum stress (psi) may be the maximum load divided by the cross-sectional area, or the thickness multiplied by the width of the fabric. The average elongation at break may be how much the samples stretched from their initial gauge length, which was 3 inches. The results of the test are shown in Table 3 below

TABLE 3

| | Sample | Maximum Load | Max Stress | Elongation |
|---|---|---|---|---|
| | No. | (lb_{f}) | (psi) | at Break (%) |
| | 1 | 3.25 | 0.002 | 178 |
| | 2 | 5.60 | 0.004 | 212 |
| | 3 | 5.98 | 0.004 | 251 |
| | 4 | 5.51 | 0.004 | 246 |
| | 5 | 4.66 | 0.003 | 262 |
| Average | | 5.00 | 0.003 | 230 |
| [Std. Dev.] | | [1.09] | [0.001] | [34.4] |

As shown in Table 3, the strips had an average elongation at break of about 230%, and an average tensile strength of about 0.003 psi. The tensile strength may range from about 0.001 psi to about 0.01 psi (e.g., about 0.002 psi to about 0.008 psi or about 0.003 psi to about 0.007 psi).

### Example 2

About 32 grams (g) of 225 bloom and 25 mesh beef gelatin available from Great Lakes Gelatin Company of Grayslake, Ill., is combined with 4 g SweetLeaf® Organic Choice Blend stevia leaf extract obtained from Wisdom Natural Brands, about 0.189 g powdered potassium sorbate, about 45 g of food-grade glycerin, about 0.64 g citric acid, about 100 g water, and two drops of cinnamon oil to form a second edible composition. The second edible composition may be used as an edible glue for adhering other edible structures together.

In at least one example embodiment, the second edible composition of Example 2 has a shell life of at least about 1 month when subjected to room temperature shelf life testing according to Salmonella RapidCheck® AOAO 080601, Listeria RapidCheck® AOAO 920401, and E Coli Petri Film AOAC 991.4 at a temperature of about 68° F. Table 4, below, provides the aerobic plate count and total coliform count over 30 days.

TABLE 4

| | | Aerobic | Total | |
|---|---|---|---|---|
| Shelf Life | Dated | Plate Count | Coliform | Yeast and Mold |
| Study | Tested | CFU/g | CFU/mL | CFU/g |
| Day 0 | Dec. 16, 2015 | <10 | <10 | <10 yeast/ |
| | | | | <10 mold |
| Day 5 | Dec. 21, 2015 | <10 | <10 | <10 yeast/ |
| | | | | <10 mold |
| Day 14 | Dec. 30, 2015 | <10 | <10 | <10 yeast/ |
| | | | | <10 mold |
| Day 30 | Jan. 15, 2016 | <10 | <10 | <10 yeast/ |
| | | | | <10 mold |

As shown in Table 4, the second edible composition remained stable without any microbial contamination throughout a 30 day shelf life study.

Strips of the second edible composition may have an average elongation at break of about 230%, and an average tensile strength of about 0.003 psi. The tensile strength of the second edible composition may range from about 0.001 psi to about 0.01 psi (e.g., about 0.002 psi to about 0.008 psi or a bout 0.003 psi to about 0.007 psi).

### Example 3

About 32 grams (g) of 225 bloom and 25 mesh beef gelatin available from Great Lakes Gelatin Company of Grayslake, Ill., is combined with 4 g SweetLeaf® Organic Choice Blend stevia leaf extract obtained from Wisdom Natural Brands, about 0.189 g powdered potassium sorbate, about 45 g of food grade glycerin, about 0.64 g citric acid, about 100 g water and about 31.2 g high fructose corn syrup 42 to form a third edible composition. The third edible composition is liquid when formed. The edible composition may be placed in a mold and allowed to dry to form a molded body.

For example, the third edible composition may be placed in lace molds made to mimic real lace. The third edible composition may be clear, but a colorant may be added to provide a colored edible lace. The lace may remain flexible, stretchy, and/or pliable when dry. The resulting lace may have clean and smooth edges and an appearance of real lace.

In at least one example embodiment, the lace may be formed in individual sections. The sections may be attached to each other by applying a small amount of the third edible composition to the edges being attached. The transition between sections of the lace may be seamless, such that the lace appears to be a single long piece of lace. The long piece of lace may be applied to edible clothing, cakes, and/or other edible articles

To determine a tensile strength of the third edible composition, the third edible composition was thinly spread on a silicone sheet and then cut into 1-inch by 6-inch strips, each strip having a thickness ranging from about 0.0280 inch to about 0.0150 inch.

Each strip was put in a universal testing machine that conducts tension and compression style testing according to ASTM D5035-11 (2015). Because of the added corn syrup, the stretch before break distance was longer than for the first edible composition. The test strips had an average elongation at break of about 280%, and an average tensile strength of about 0.004 psi. The tensile strength may range from about 0.001 psi to about 0.01 psi (e.g., about 0.002 psi to about 0.008 psi or about 0.003 psi to about 0.007 psi)

### Example 4

The second edible composition of Example 2 and the first edible composition of Example 1 are combined in about a 75:25 mixture to form a fourth edible composition. The fourth edible composition may be applied to wafer paper or may be used alone to form a material that is more rigid than the first edible composition when dried, but still remains flexible and/or pliable. The fourth edible composition may be used to form flowers. The fourth edible composition may also be painted over a form or mold, and may retain a shape of the form or mold when dried.

### Example 5

The first edible composition may include the same ingredients as in Example 1, but with double an amount of gelatin to form a fifth edible composition that has greater rigidity than the first edible composition. The fifth edible composition remains flexible and/or pliable when dried and should not crack.

Each of the first, second, third, fourth, and fifth edible compositions may be liquid when formed, but may thy to form a flexible material in a gel-like and/or solid form. In at least one example embodiment, the edible compositions may dry to a gel-like form in about 5 minutes to about 20 minutes (e.g., about 8 minutes to about 16 minutes or about 10 minutes to about 14 minutes). The edible composition may fully dry in about 5 hours to about 36 hours. Once partially or fully dried, the edible composition may maintain flexibility, and may be folded, bent, stretched, and/or otherwise manipulated without breaking and/or cracking. The edible composition may remain pliable and/or generally soft to the touch.

In at least one example embodiment, once dry, the edible composition may be heated to a temperature ranging from about 120° F. to about 160° F. to change the physical state of the edible composition from a gel or solid back to a liquid and/or semi-liquid form, which may then be used to create different edible articles. Water may also be added to assist in changing the physical state of the edible composition. However, contacting dried edible articles with small amounts of moisture should not alter the shape and/or form thereof.

In at least one example embodiment, for example, a gel and/or solid edible composition may be placed in a 950 watt microwave for at least about 15 seconds to change the dried edible composition into liquid and/or semi-liquid edible composition that may be reused to form other articles. Thus, once the edible composition has been molded or formed in shapes, the molded or formed shapes may be reheated to at least partially liquefy the edible composition so that it may be reused and/or reformed into other shapes. Instead of healing in a microwave, in at least one example embodiment, the edible composition may be heated and/or melted in an oven, on a stove, on a hot/warming plate, and/or over a fire.

In at least one example embodiment, the edible compositions may be frozen and/or thawed without altering the flexibility and/or stretchiness of the edible composition. When frozen, the edible compositions may retain about the same consistency as when at room temperature. In at least one example embodiment, the edible composition may not harden like an ice cube when frozen.

In at least one example embodiment, the edible compositions may be used to form edible articles including cake decorations, edible clothing, and the like as described below and shown in the accompanying figures.

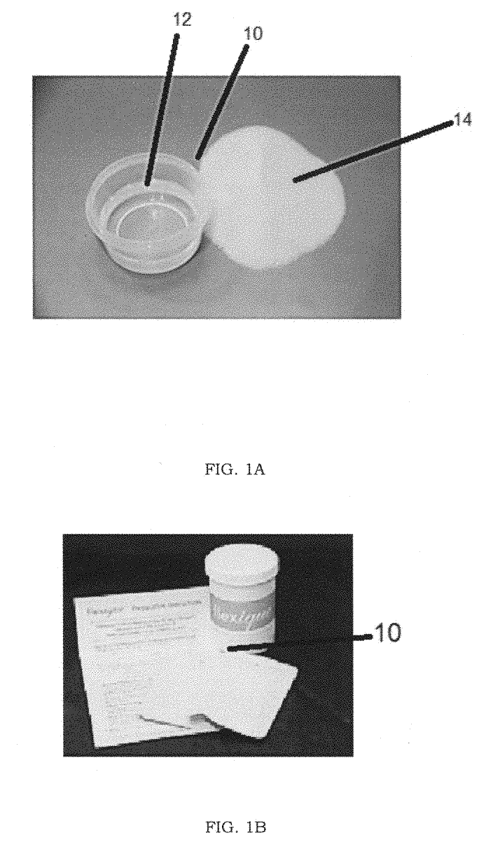

FIGS. 1A and 1B are illustrations of a kit including ingredients of an edible composition according to at least one example embodiment.

In at least one example embodiment, as shown in FIGS. 1A and 1B, the ingredients of the edible composition according to at least one example embodiment, may be packaged and/or sold as a kit 10 including a container of dry ingredients 14 and a container of liquid ingredients 12. By keeping the dry ingredients 14 and the liquid ingredients 12 separate, shelf life may be extended. The kit may also include instructions for mixing the liquid ingredients 12, dry ingredients 14, and water to form the edible composition according to at least one example embodiment.

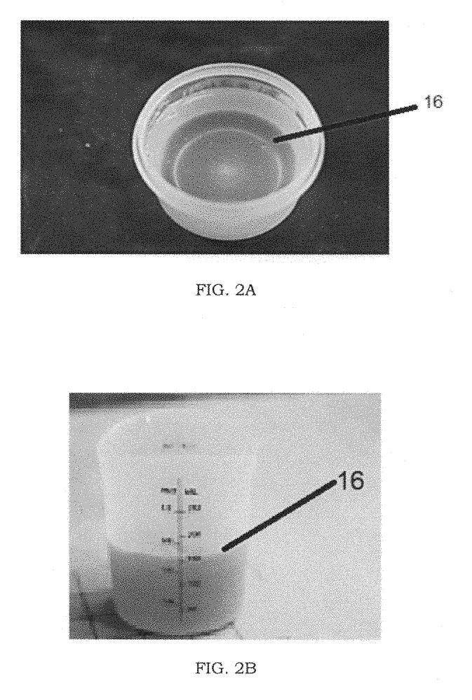

FIGS. 2A and 2B are illustration of an edible composition in liquid and/or semi-liquid form according to al least one example embodiment.

In at least one example embodiment, as shown in FIGS. 2A and 2B, once the dry ingredients 14 and liquid ingredients 12 are mixed with a desired amount of water. In at least one example embodiment, the water may be any tap water, distilled water, flavored water, or sugar water at a temperature ranging from about 60° F. to about 160° F. (e.g., about 65° F. to about 155° F., about 70° F. to about 150° F., about 75° F. to about 145° F., about 80° F. to about 140° F., about 85° F. to about 135° F., or about 90° F. to about 130° F.). Once the dry ingredients 14, the liquid ingredients 12, and the water are mixed, an edible composition in liquid and/or semi-liquid form 16 may be formed. In at least one example embodiment, the edible composition 16 is a clear liquid.

FIG. 3 is an illustration of an edible composition in gel and/or solid form according to at least one example embodiment. The first, second, third, and fourth edible compositions set forth above may each be in gel and/or solid form when set.

In at least one example embodiment, once the liquid and/or semi-liquid form 16 may be formed and dries as described herein, an edible composition in a gel and/or solid form 18 may be obtained. The gel and/or solid edible composition may be converted to a liquid and/or semi-liquid by heating and/or adding water as described herein.

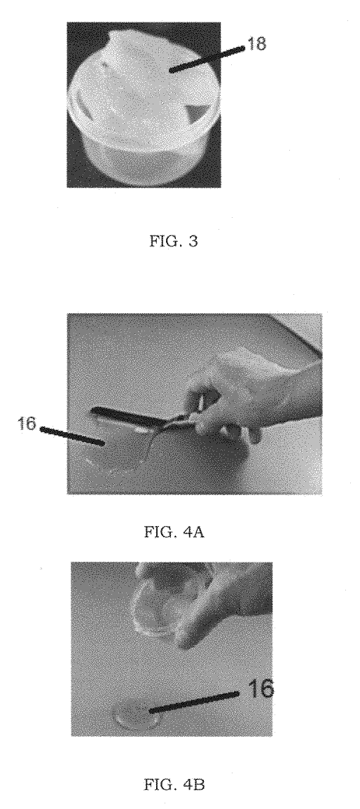

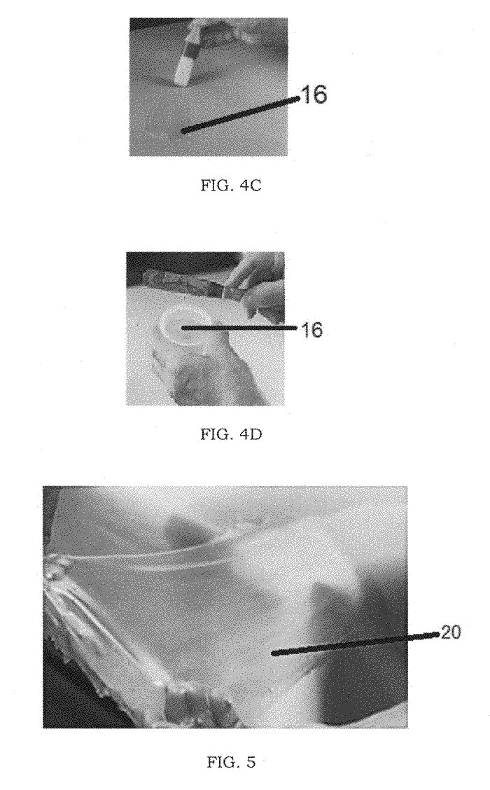

FIGS. 4A, 4B, 4C, and 4D are illustrations of an edible composition spread on a flat surface according to at least one example embodiment.

In at least one example embodiment, before the edible composition in liquid and/or semi-liquid form 16 dries, the edible composition may be spread on any suitable material to form one or more sheets of edible material and/or an edible sealant over a fresh food product.

FIG. 5 is an illustration of a sheet of an edible composition according to at least one example embodiment.

In at least one example embodiment, a sheet 20 of edible composition may be formed by spreading the first edible composition in liquid and/or semi-liquid form 16 on a flat surface and peeling the edible composition from the flat surface once dried. The sheet 20 remains bendable, pliable, foldable, and stretchable even when dried.

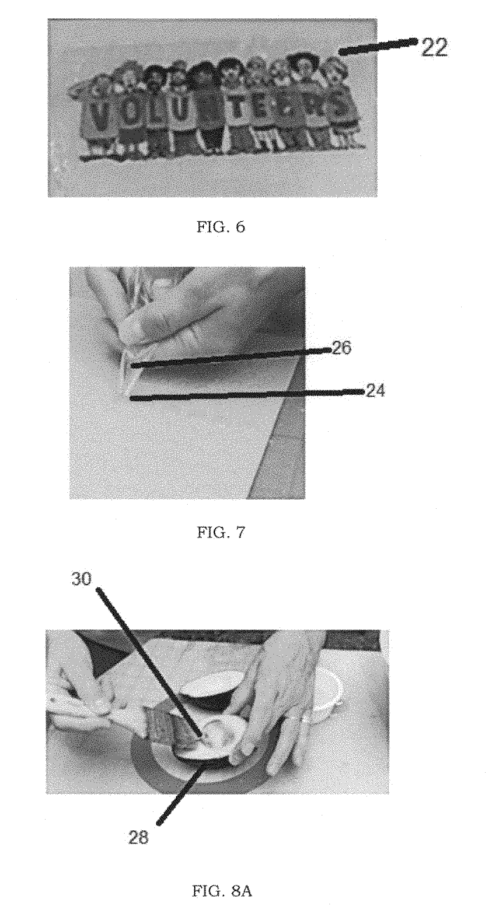

FIG. 6 is an illustration of a printed sheet of an edible composition according to at least one example embodiment.

In at least one example embodiment, the edible composition may be formed into the sheet 20 as described above when laid onto an acrylic hacking and left to dry. The sheet 20 may be printed with edible inks to form a printed sheet 20. The inks should not smear or run even when contacted with moisture, such as when applied to a cake. Thus, the printed sheets 20 may be used to decorate cakes in advance without risk of having the ink run onto other portions of the cake. In addition, because the printed sheets 20 remain pliable, the sheets 20 should not break and/or crack during transport and/or while being applied to cakes or other products.

In at least one example embodiment, the edible sheet 20 is generally transparent so that any image printed thereon is clear. In other example embodiments, the sheet 20 may also be colored in any colors to complement the image being printed on it.

FIG. 7 is an illustration of an edible composition in liquid form being piped according to at least one example embodiment.

In at least one example embodiment, the edible composition in liquid and/or semi-liquid form 16 may be piped through a piping bag 26 onto cakes or other surfaces to create edible decorations 24. The edible decorations 24 may be pliable and/or stretchy. The first, second, third, and fourth edible compositions described above may be piped.

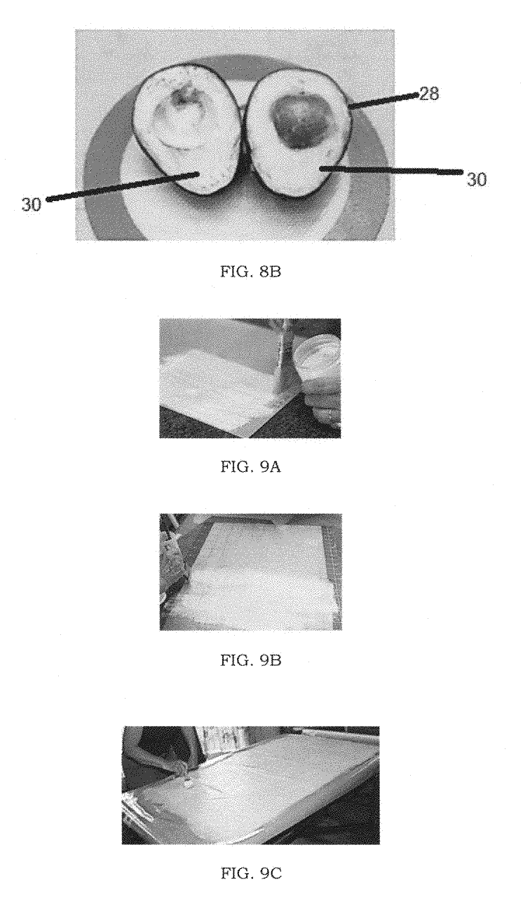

FIGS. 8A and 8B are illustrations of an edible composition applied to fresh fruit as a sealant according to at least one example embodiment.

In at least one example embodiment, as shown in FIGS. 8A and 8B, the edible composition in liquid and or semi-liquid form 16 may be brushed onto or otherwise applied to a surface of a fresh fruit, vegetable, or tether food product 28, alone or in addition to an acidic agent. The edible composition 16 forms a sealant 30 on the food product 28, which protects the food product 28 from browning, but may not protect from rot. For example, as shown, the edible composition 16 may be applied to a cut avocado to prevent browning of the avocado and maintain freshness thereof. The sealant 30 may protect the fresh food from browning for at least about one week or longer. The sealant 30 may slow and/or prevent oxidation, even without an avocado pit. The sealant 30 may be applied to fresh foods to aid in food photography.

In at least one example embodiment, the first, second, and/or third edible compositions of Examples 1-3 may be used as the sealant.

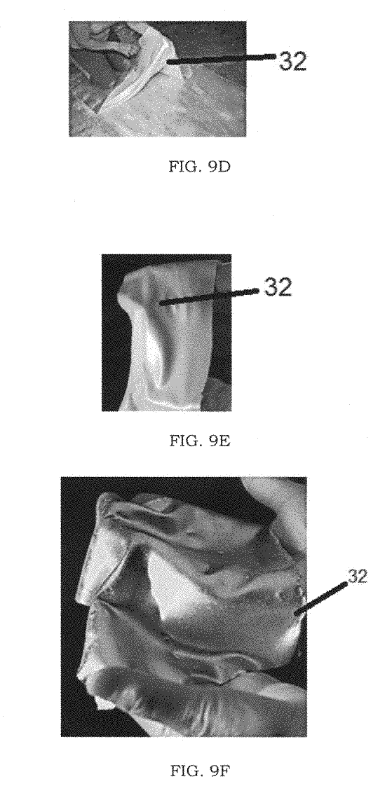

FIGS. 9A, 9B, 9C, 9D, 9E, and 9F are illustrations of an edible fabric formed from an edible composition according to at least one example embodiment.

In at least one example embodiment, the edible composition in liquid and/or semi-liquid form may be spread on a flat surface and allowed to dry to form an edible fabric 32. The edible fabric 32 maintains flexibility and stretchiness when dried. The edible fabric 32 may be embossed, painted with edible paint, lustered with edible luster dust, cut, sewn, glued, and/or used to make any desired edible decoration. For example, the edible fabric 32 may be used to form edible bags, edible clothing, edible hats, edible gloves, edible scarves, edible jewelry, and the like.

In at least one example embodiment, the first and/or second edible compositions of Examples 1-2 may be used to form the edible fabric. In at least one example embodiment, the edible fabric may be formed by combining the first and/or second edible compositions with one or more of any confectionary candy, chocolate almond bark, etc. for to form a fabric having a thicker and more durable consistency. Moreover, candies, herbs, and/or other botanical materials may be embedded in the edible fabrics.

FIGS. 10A and 10B are illustrations of an edible composition used as body paint according to at least one example embodiment.

In at least one example embodiment, as shown in FIGS. 10A and 10B, the edible composition in liquid and/or semi-liquid form 16 may be used as an edible paint and/or body paint 34 that may be applied to any surface including portions of the body. The edible paint 34 may include any colorant to provide a desired paint color. The edible paint 34 may also include any flavorant and/or aromatic agent to provide an edible paint 34 having a desirable flavor and smell. The edible paint 34 may be pre-mixed and packaged. The edible paint 34 may have a shelf life of at least about 1 month. The paint may be formed using the first edible composition of Example 1 above.

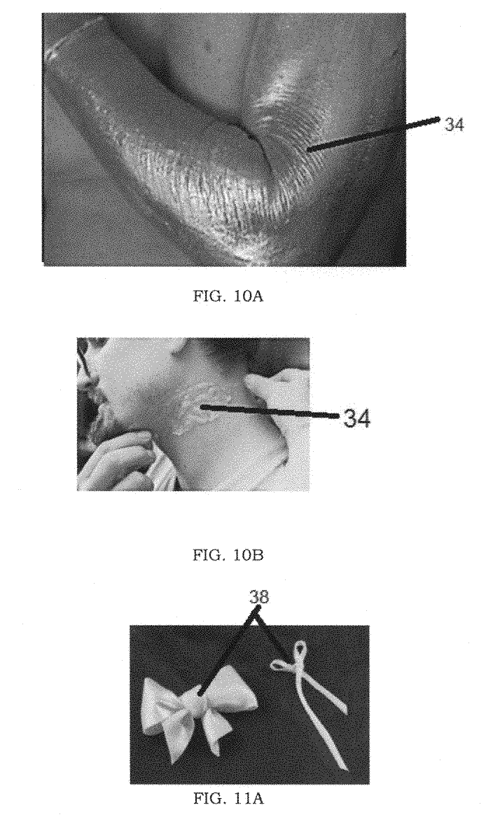

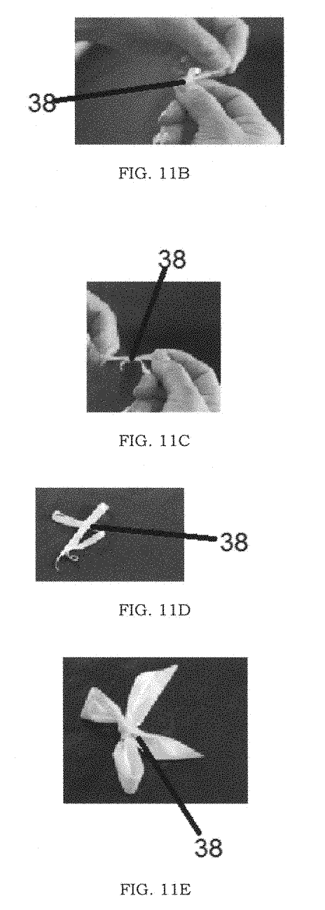

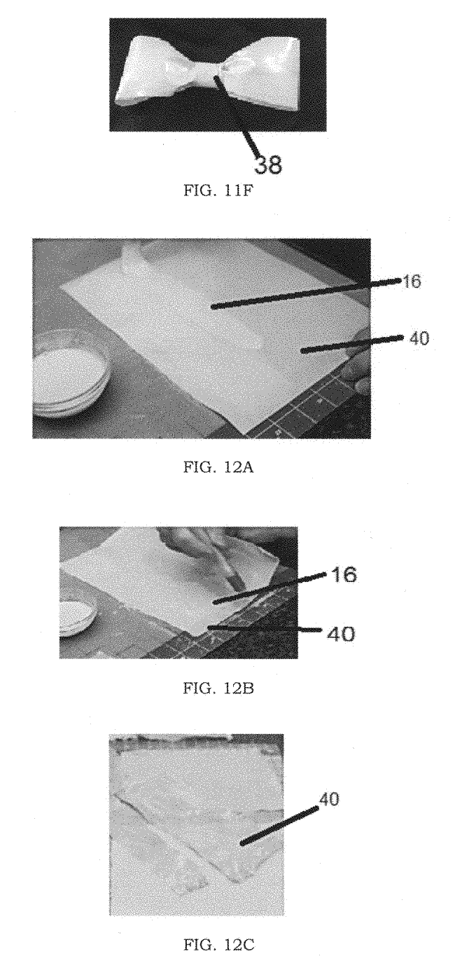

FIGS. 11A, 11B, 11C, 11D, 11E, and 11F are illustrations of bows formed of an edible fabric according to at least one example embodiment.

In at least one example embodiment, as shown in FIGS. 11A, 11B, 11C, 11D, 11E, and 11F, once an edible fabric 32 may be formed as described above, strips may be cut from the edible fabric 32, and the strips may be formed into bows 38 that remain flexible and stretchy. The bows 38 should not crack during the lying process. The bows 38 have a similar appearance and feel of bows formed or ribbon and/or fabrics. Thus, the bows 38 may be used in edible clothing or for decoration on food products.

In at least one example embodiment, the first and/or second edible compositions of Examples 1-2 may be used as to form the edible fabric. In at least one example embodiment, the first and/or second edible compositions may be combined with chocolate and/or other materials to form an edible fabric.

FIGS. 12A, 12B, and 12C are illustrations of an edible composition applied to wafer paper according to at least one example embodiment.

In at least one example embodiment, as shown in FIGS. 12A, 12B, and 12C, the edible composition in liquid and/or semi-liquid form 16 may be applied to one or both sides of a sheet of wafer paper to form a reinforced wafer paper 40. A very thin application of the edible composition may result in greater rigidity over time than a thicker application, which may retain greater flexibility. The edible composition may be applied at a thickness ranging from about 1/64 inch to about ⅛ inch to one or both sides of the wafer paper. Instead of being applied to wafer paper, the edible composition may be applied to rice paper and/or icing sheets. The composition may be absorbed into the coated product so as to provide elasticity without breakage. It may be used on regular paper to preserve the print, but then may no longer be edible. The reinforced wafer paper 40 may maintain flexibility and/or stretchiness after drying, and may be folded, bent, and/or glued to other sheets of reinforced wafer paper 40 to form larger and/or thicker edible decorations and/or clothing. In at least one example embodiment, instead of wafer paper, rice paper, or other edible papers may be used.

In at least one example embodiment, the first and/or second edible compositions of Examples 1-2 may be used to form the reinforced wafer paper 40.

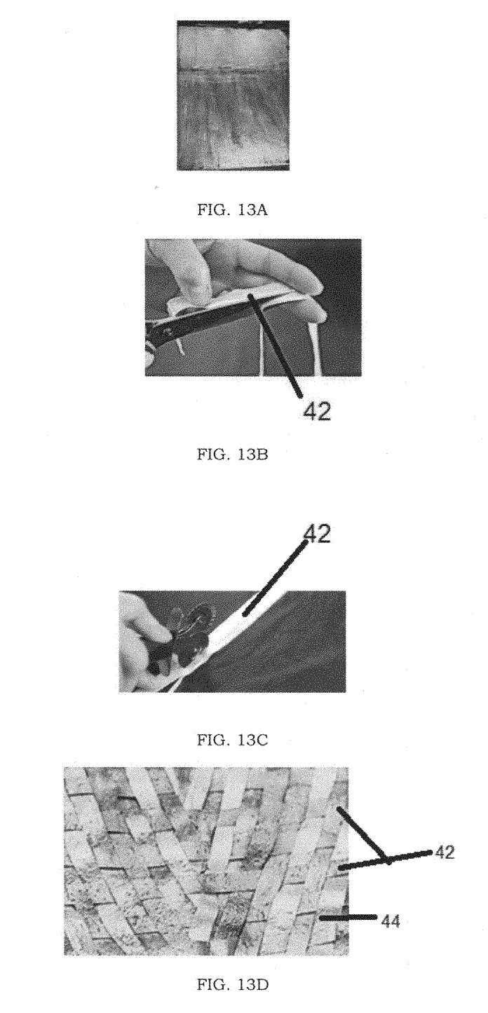

FIGS. 13A, 13B, 13C, and 13D are illustration of strips being cut and woven to form an edible fabric according to at least one example embodiment.

In at least one example embodiment, as shown in FIGS. 13A, 13B, 13C, and 13D, the edible fabric 32 of FIGS. 9A-9E and/or the edible sheet 20 of FIG. 5 may be cut into strips 42 and woven together to form a woven fabric 44. Because the strips 42 remain flexible and stretchy when dried, the strips 42 should not crack and/or break during weaving and the resulting woven fabric 44 may be flexible and/or stretchy. The woven fabric 44 may be used to form edible clothing, baskets, or basket weave-type decorations for cakes or other edible food products. In at least one example embodiment, the strips may be colored and/or flavored before weaving so that the woven fabric 44 includes portions having different colorants and/or flavorants. In other example embodiments, the strips of the woven fabric 44 may include the same colorants and/or flavorants.

In at least one example embodiment, the first and/or second edible compositions of Examples 1-2 may be used as to form the edible fabric. In at least one example embodiment, the first and/or second edible compositions may be combined with chocolate and/or other materials to form an edible fabric.

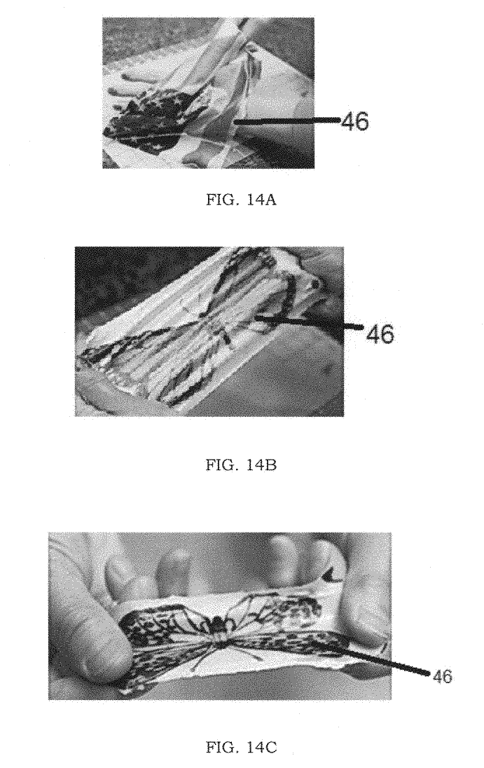

FIGS. 14A, 14B, and 14C are illustrations of a printed edible sheet according to at least one example embodiment.

In at least one example embodiment, as shown in FIGS. 14A, 14B, and 14C, the reinforced wafer paper 40 of FIGS. 12A, 12B, and 12C may be printed with edible inks to form a printed, reinforced edible paper 46. The edible inks should not smear or run when in contact with moisture. The printed, reinforced edible paper 46 may remain flexible and/or stretchy after drying. The first edible composition of Example 1 may be used to form the reinforced wafer paper.

In at least one example embodiment, the printed edible sheet may be cut into shapes that may be applied to a body as a temporary tattoo.

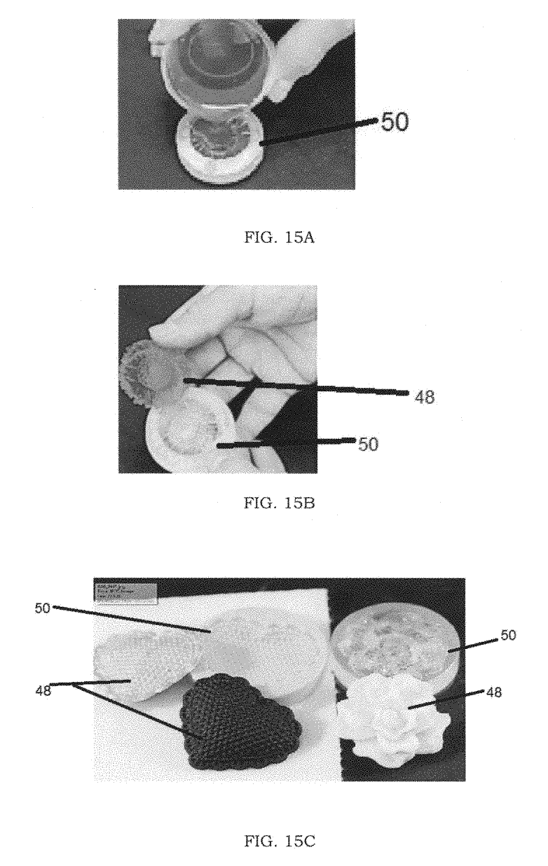

FIGS. 15A, 15B, and 15C are illustrations of a molded decoration formed of an edible composition according to at least one example embodiment.

In at least one example embodiment, as shown in FIGS. 15A, 15B, and 15C, the edible composition in liquid and/or semi-liquid form 16 may be piped or otherwise placed in a mold 50. During drying, the edible composition may shrink slightly, which allows for easy removal of the molded shapes 4R from the mold 50 when dried. The molded shapes 48 may be used as edible decorations. The molded shapes 48 may remain flexible and/or stretchy after drying, and may have a texture similar to gummi bears. The molded shapes 48, and other edible decorations described herein, may not be sticky when in contact with moisture.

In at least one example embodiment, the first, second, and/or third edible compositions of Examples 1-3 may be used to form clear and flexible molded shapes 48. In other example embodiments, the first, second, and/or third edible compositions may be combined in a ratio of about 25:75 to about 75:25 of the first, second, and/or third edible composition and at least one of fondant, gum paste, or pastillage to form a substantially opaque molded shape 48 that may harden upon drying.

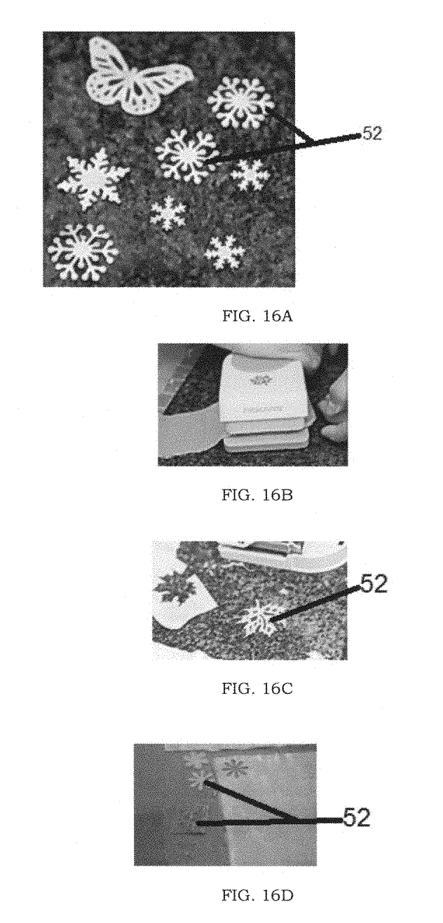

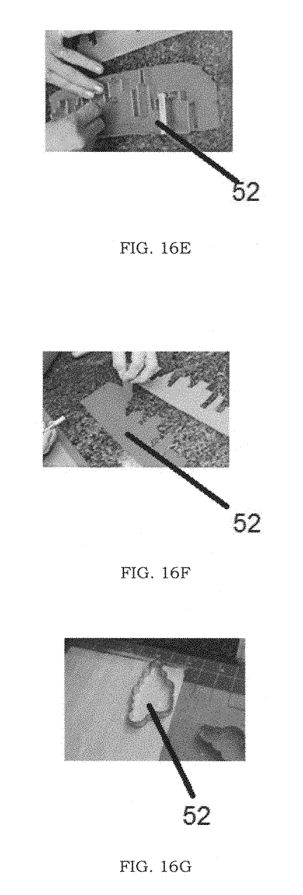

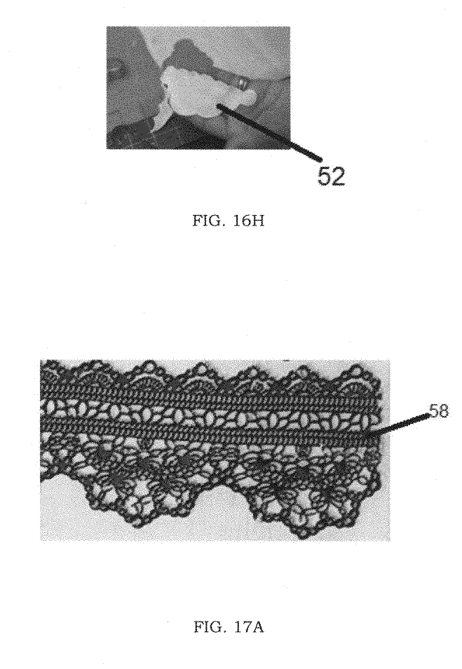

FIGS. 16A, 16B, 16C, 16D, 16E, 16F, 16G, and 16H are illustrations of shapes cut out of an edible sheet according to at least one example embodiment.

In at least one example embodiment, as shown in FIGS. 16A, 16B, 16C, 16D, 16E, 16F, 16G, and 16H, the edible fabric 32 of FIGS. 9A-9E and/or the edible sheet 20 of FIG. 5 may be used to form punch out or cut-out shapes 52 using cookie cutters or other shape cutters. Any suitable cutting device may be used to form the shapes 52. The shapes 52 remain flexible and/or stretchy after drying.

In at least one example embodiment, the first, second, third, and fourth edible compositions discussed above, alone or in combination, may be used to form cutouts. The cutouts may also be formed from reinforced wafer papers coated with the edible composition.

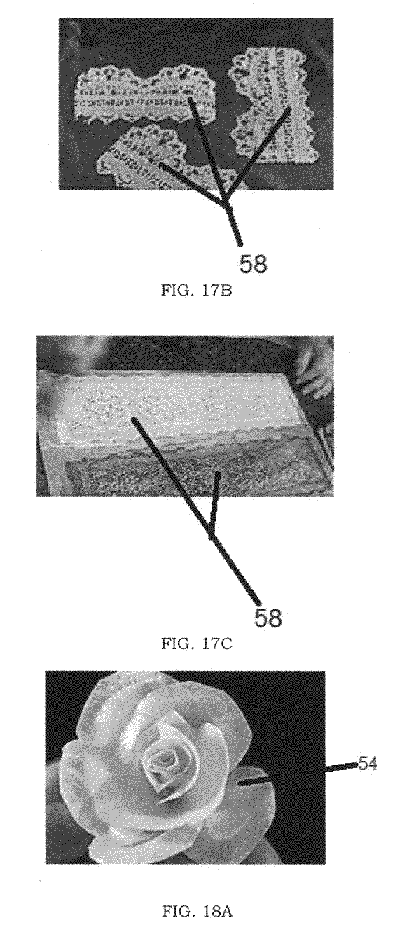

FIGS. 17A, 17B, and 17C are illustrations of edible lace formed of an edible composition according to at least one example embodiment.

In at least one example embodiment, as shown in FIGS. 17A, 17B, and 17C, the third edible composition of Example 3 may be piped or otherwise placed into lace molds to form edible lace 58 for use on wedding cakes or other desired edible products. The lace molds may be formed from actual lace so that the edible lace 58 may be made to mimic lace on a wedding dress, veil, or other clothing item. A light greasing of the mold surface with shortening may aid in removal of the cured product. Because the edible composition is clear unless colorant is added, the lace may be clear or any other color, whereas fondant lace and/or other edible laces are white due to the compositions of those materials.

While other edible compositions may be used in lieu of the third edible composition, other edible compositions may adhere to intended blank spaces within the lace mold. In contrast, the third edible composition flows naturally away from the intended blank spaces so as to produce a clean rendition of lace with clean edges.

In at least one example embodiment, suitable edible compositions to make edible lace may include thickening agent in an amount ranging from about 5% to 21% by weight based on the weight of the edible composition, sweetener in an amount ranging from about 0.6% to about 5.1% by weight based on the weight of the edible composition, water in an amount ranging from about 19% to about 38% by weight based on the weight of the edible composition, humectant in an amount ranging from about 6% to about 42% by weight based on the weight of the edible composition, an optional preservative in an amount of up to about 0.1% by weight based on the weight of the edible composition, citric acid in an amount ranging from about 0.6% to about 2.6% by weight based on the weight of the edible composition, about 1 to about 4 drops of cinnamon oil or other additive, and high fructose corn syrup—42% fructose (HFCS-42) in an amount ranging from about 12% to about 57% by weight based on the weight of the edible composition.

In at least one example embodiment, as set forth above, the lace may be formed in short sections, which may be seamlessly attached to one another to form a long piece of edible lace by using a small portion of the edible composition used to form the edible lace as a glue between—sections.

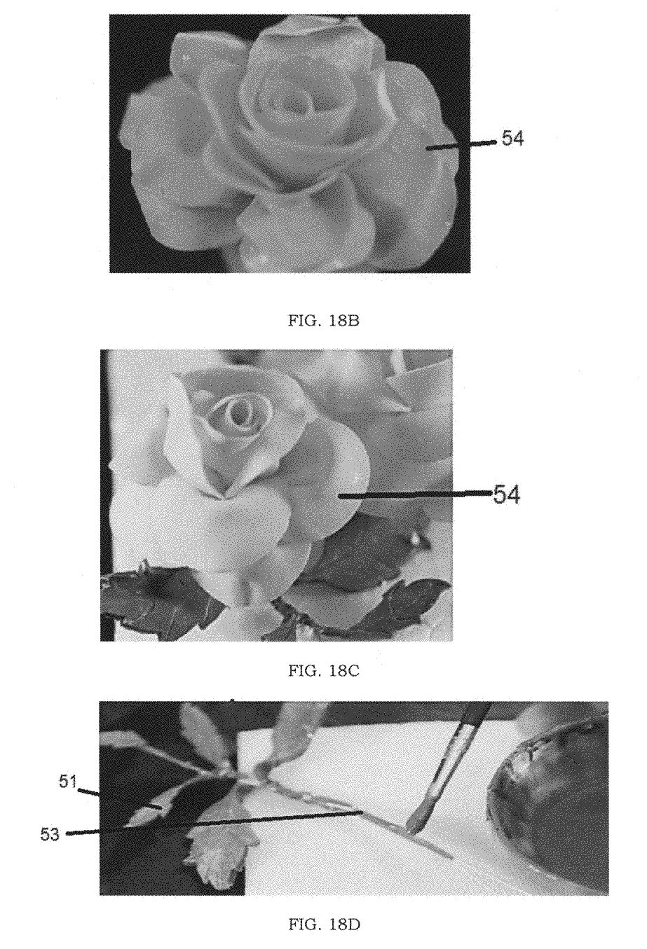

FIGS. 18A, 18B, 18C, and 18D are illustrations of an edible rose, leaves, and coated stem formed from the edible composition according to at least one example embodiment.

In at least one example embodiment, as shown in FIGS. 18A, 18B, and 18C, the edible fabric 32 of FIGS. 9A-9E and/or the edible sheet 20 of FIG. 5 may be cut into petal-like shapes that may be glued together to form edible flowers 54. Edible glue may be formed using the second edible composition of Example 2 as set forth above. The glue may be tacky and may hold the petals together, while allowing the petals to maintain flexibility and stretchiness so as to mimic real flowers. The stems of both the flowers and the leaves may be coated with the first edible composition or another edible composition. The stem may functions like floral tape, but is edible so that the stems may be safely inserted into a cake.

In other example embodiments, the edible compositions may be used to coat real flower stems so that the flower stems may be safely inserted into a cake without concern of pesticides, bacteria, and/or other non-edible substances. In, other example embodiments, the edible compositions may be used to coat bark, rocks, and/or any other natural or synthetic (e.g., plastic, wood, and/or metal) materials that may be used to decorate cakes or other edible products. The coating may protect the edible product from contamination.

In at least one example embodiment, as shown in FIG. 18D, leaves 51 and/or stems 53 may be formed of the edible compositions.

In at least one example embodiment, the first and/or second edible compositions of Examples 1 and 2 may be used to form the flowers, stems, and/or leaves.

Thus, in contrast to pulled sugar or gum paste flowers, the edible flowers 54 should not break or crack during decorating and transport of a decorated cake or other food product.

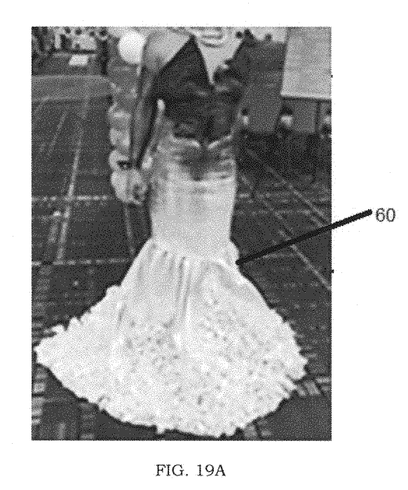

FIGS. 19A and 19B are illustrations of dresses formed of an edible composition according to at least one example embodiment.

In at least one example embodiment, as shown in FIGS. 19A and 19B, the edible fabric 32 of FIGS. 9A-9E and/or the edible sheet 20 of FIG. 5, may be combined and glued together and/or otherwise joined together to form a dress 60. The dress 60 may be stretchy and may move like many fabrics when worn. Thus, the dress 60 may not be rigid.

In at least one example embodiment, the edible fabric 32 of FIGS. 9A-9E and/or the edible sheet 20 of FIG. 5 may also be used to form other edible clothing articles including shirts, pants, underwear, socks, and the like.

In at least one example embodiment, the first and second edible compositions of Examples 1 and 2 may be used to form the edible fabric and/or portions of the edible dress 60.

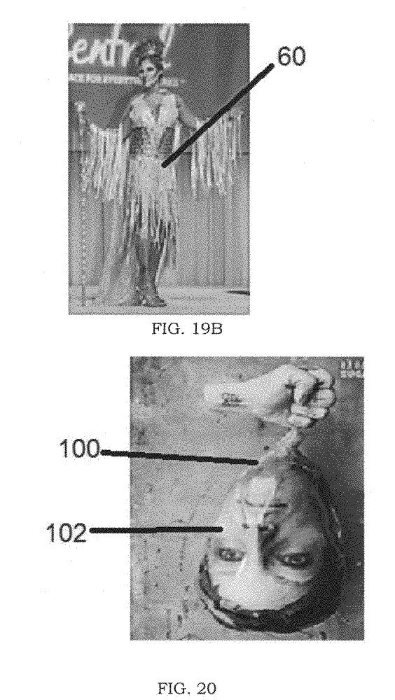

FIG. 20 is an illustration of an edible bag and mask formed of an edible composition according to at least one example embodiment.

In at least one example embodiment, as shown in FIG. 20, the edible composition in liquid and/or semi-liquid form 16 may be poured into molds to form edible prosthetics and/or masks 102, which may be packaged in edible bags 100. For example, the edible compositions described herein may be used to form Halloween masks, fake noses and ears, fake lips and teeth, and the like. For example, the bag and/or prosthetics may be formed using the first edible composition of Example 1.

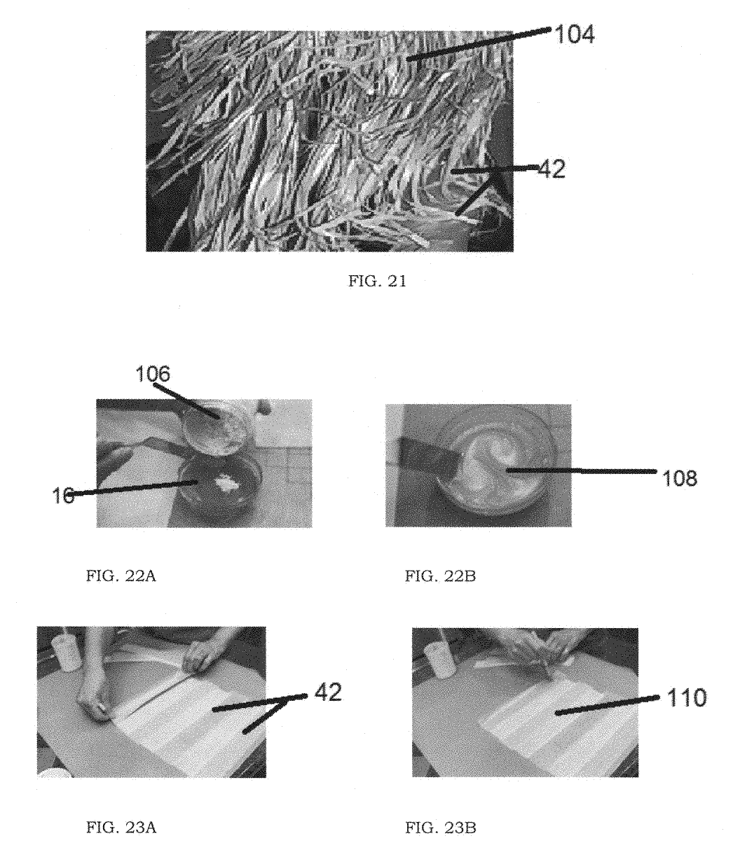

FIG. 21 is an illustration of a fringe formed of strips formed from an edible composition according to at least one example embodiment.

In at least one example embodiment, as shown in FIG. 21, strips 42 made of an edible composition may be joined together to form a fringed material 104. The fringed material 104 may be used to form a portion of an edible dress of FIG. 19B.

In at least one example embodiment, the first and second edible compositions of Examples 1 and 2 may be used to form the fringed material 104, which may form a portion of the edible dress 60 of FIG. 19B.

FIGS. 22A and 22B are illustrations of an edible composition being mixed with luster dust according to at least one example embodiment.

In at least one example embodiment, as shown in FIGS. 22A and 22B, the edible composition in liquid and/or semi-liquid form 16 may be mixed with luster dust 106 to form a lustered edible composition 108.

In at least one example embodiment, the first, second, and/or third edible compositions of Examples 1, 2, and 3 may be used mixed with luster dust as shown.

FIGS. 23A and 23B are illustrations of strips of edible sheets being glued together to form larger sheets according to at least one example embodiment.

In at least one example embodiment, strips 42 formed of an edible composition may be glued together or otherwise joined together to form larger sheets 110 including a plurality of strips 42.

FIGS. 24A and 24B are illustrations of colorant being added to an edible composition to form a colored edible composition according to at least one example embodiment.

In at least one example embodiment, as shown in FIGS. 24A and 24B, the edible composition in liquid and/or semi-liquid form 16 may be combined with a colorant 112 to form a colored edible composition 114.

In at least one example embodiment, any of the edible compositions described herein may be combined with the colorant 112 to form the colored edible composition.

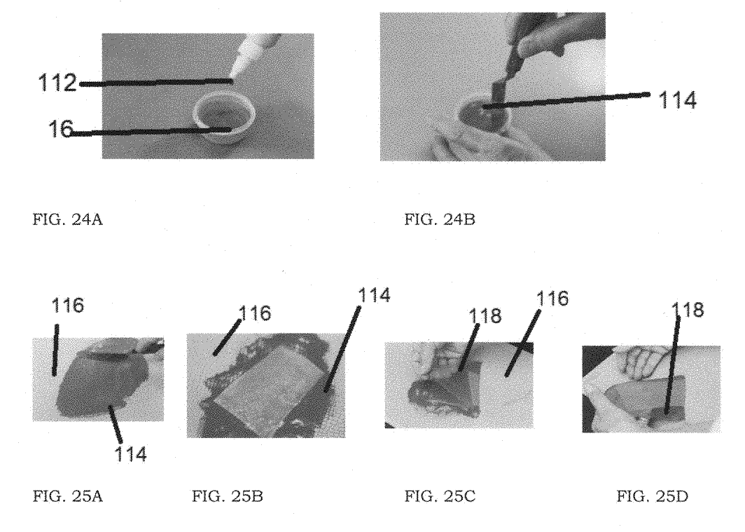

FIGS. 25A, 25B, 25C, and 25D are illustrations of the colored edible composition of FIGS. 24A and 24B being spread on a textured mold and/or surface to form a textured edible material according to at least one example embodiment.

In at least one example embodiment, as shown in FIGS. 25A, 25B, 25C, and 25D, the colored edible composition 114 may be spread on a textured surface 116 to form a textured material 118.

In at least one example embodiment, any of the edible compositions described herein may be spread on the textured surface 116 to form a textured material 118.

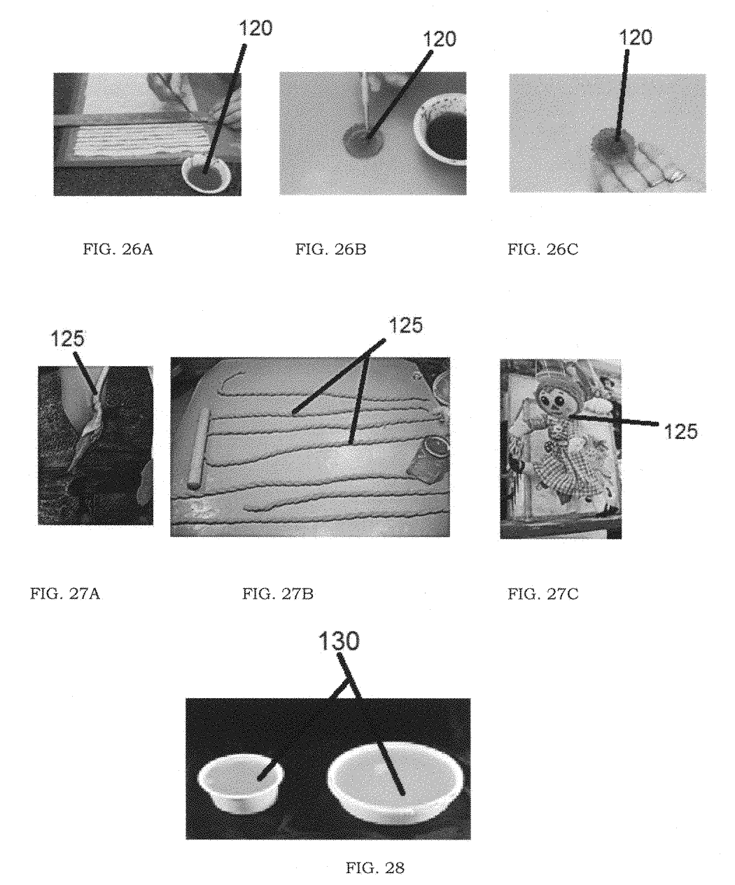

FIGS. 26A, 26B, and 26C are illustrations of an edible composition being used as an edible paint according to at least one example embodiment.

In at least one example embodiment, as shown in FIGS. 26A, 26B, and 26C, the edible composition may be mixed with an additional amount of water to form an edible paint 120. For example, the edible composition may be combined with water in an amount of up to about 50% by weight based on the weight of the edible paint 120. The edible paint 120 may be easily applied with a paint brush or other implement. The edible paint 120 may quickly adhere to and/or dry on other edible decorations formed of the edible compositions described herein.

In at least one example embodiment, any of the edible compositions described herein, alone or in any combination, may be used as the edible paint 120.

FIGS. 27A, 27B, and 27C are illustrations of sculptures formed from a combination of an edible composition and one or more of fondant or gum paste according to at least one example embodiment.

In at least one example embodiment, as shown in FIGS. 27A, 27B, and 27C, the first edible composition of Example 1 in liquid and/or semi-liquid form 16 may be combined in a ratio of about 50:50 with at least one of fondant, pastillage, or gum paste, which can be spread onto a texture sheet to form a more rigid but still slightly flexible material like in the black dress top of FIG. 27A. This allows for easier handling as compared to plain fondant or gum paste with little or no breakage. The first edible composition may be combined in a 25:75 ratio of edible composition to fondant, pastillage, or gum paste to produce a material that can be formed in tubing or extruded into strings or rope and braided like in the green tube of FIG. 27A, and FIG. 27B and the hair of FIG. 27C.

FIG. 28 is an illustration of a pre-mixed edible composition according to at least one example embodiment.

In at least one example embodiment, as shown in FIG. 28, the liquid and dry ingredients can be pre-mixed and sold as a pre-mixed edible composition 130. For example, the second, third, fourth, and fifth compositions of Examples 2-5 may be pre-mixed and sold.

FIGS. 29A and 29B are illustrations of an edible fabric being formed into an edible skirt according to at least one example embodiment.

In at least one example embodiment, as shown in FIGS. 29A and 29B, the edible fabric 32 may be glued with an edible glue 132 to form an edible skirt 134. The edible glue may be heated and applied to both sides of the edible fabric 32 with a paintbrush. About ¼ inch of the fabric may be folded over to form a hem, and the fold is held in place for a few seconds or until the edible glue cools to maintain the hem as shown in FIG. 29A. Then, an opposing portion of the fabric may be gathered and pleated using the edible glue and/or clamps.

In at least one example embodiment, the first edible composition of Example 1 alone or in combination with wafer paper may form the edible fabric 32. The edible glue 132 may be the second edible composition of Example 2.

FIGS. 30A and 30B are illustrations of an edible fabric being formed into an edible chefs hat according to at least one example embodiment.

In at least one example embodiment, as shown in FIGS. 30A and 30B, the edible fabric 32 may be gathered to form a chef's hat. To form the chef's hat, an edible glue may be warmed, pleats 140 may be formed along a joint, the edible glue may be applied along each pleat 140 with a brush, and the pleats 140 may be held together until the edible glue has dried. The process is similar to paper maché.

In at least one example embodiment, the first edible composition of Example 1 alone or in combination with wafer paper may form the edible fabric 32. The edible glue 132 may be the second edible composition of Example 2.

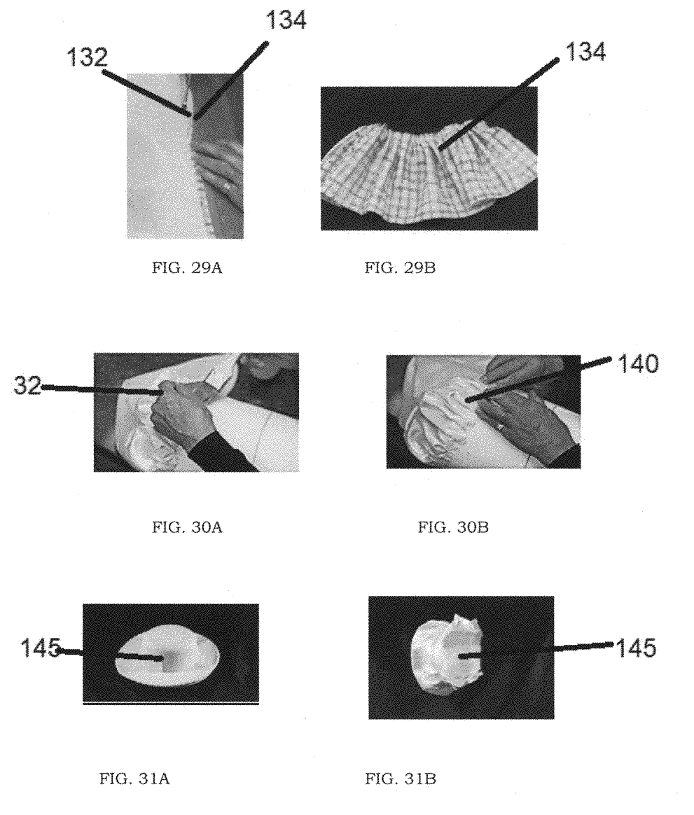

FIGS. 31A and 31B are illustrations of an edible fabric being molded around an object to form an edible hat 145 according to at least one example embodiment.

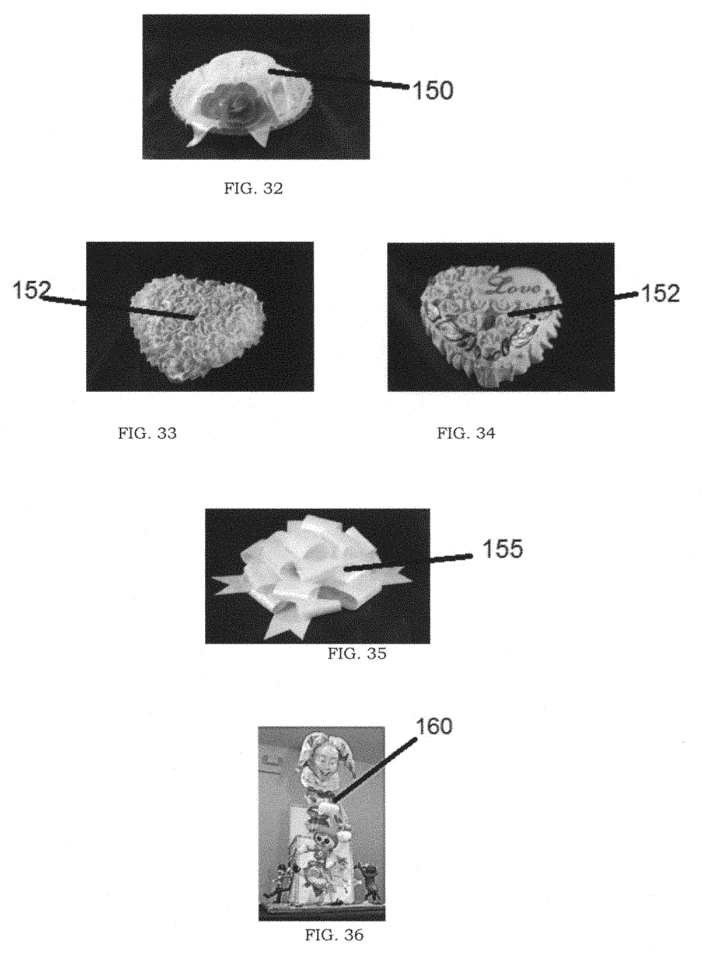

FIG. 32 is an illustration of an edible hat made from an edible composition according to at least one example embodiment.

In al least one example embodiment, as shown in FIGS. 31A and 31 and in FIG. 32, an edible fabric 32 may be molded over a shape to form a molded edible hat 145, 150. To form the hat 145, 150 the fourth edible composition may be warmed until in a liquid state (about 140° F.), painted over one side of a sheet of wafer paper, draped over a shape or mold, and then the other side may be painted. The painted sheet is dried to form a stiff reproduction of the shape or the mold used.

In at least one example embodiment, the first edible composition of Example 1 alone or in combination with wafer paper may form the edible fabric 32 used to form the edible hat 145, 150.

FIG. 33 is an Mush anon of an edible valentine made from an edible composition according to at least one example embodiment.

FIG. 34 is an illustration of an edible valentine made from an edible composition according to at least one example embodiment.

In at least one example embodiment, as shown in FIGS. 33 and 34, an edible composition may be used to form edible valentines 152. In both hearts, the edible composition may be warmed. The warmed edible composition may be painted over one side of a sheet of white wafer paper and draped over the heart shape. Then the other side may also be painted with the edible composition. Ruffles along the edge may be made with, for example, a 50:50 or 25:75 mixture of an edible composition, such as the first edible composition, and confectionery coating or of only an edible composition. The edible composition may be spread onto a silicone mat, cut into strips, gathered into pleats, and attached together with warm glue.

In at least one example embodiment, as shown in FIG. 33, a white colored edible composition may be spread on a silicone sheet and lustered with an edible pearl luster. The resulting sheet may be cut into about 1½ inch circles. Each circle may be folded into fourths and attached to the top of the heart with an edible adhesive formed from the edible composition.

In at least one example embodiment, as shown in FIG. 34, an edible composition, such as the first edible composition, may be poured into molds (like flowers or leaves), allowed to set, and removed from the mold. Then, the molded flowers and/or leaves may be attached to the heart with warm, edible glue.

In at least one example embodiment, the first, second, and/or third edible compositions of Examples 1-3 may be used to form the edible valentines 152.

FIG. 35 is an illustration of an edible gift bow made from an edible composition according to at least one example embodiment.

In at least one example embodiment, as shown in FIG. 35, an edible gift bow 155 may be formed.

In at least one example embodiment, the first, second, third, fourth, and fifth compositions of Examples 1-5 may be used to form the edible gift bow 155.

FIG. 36 is an illustration of an edible sculpture made from an edible composition according to at least one example embodiment.

In al least one example embodiment, as shown in FIG. 36, an edible sculpture 160 may be formed. The doll's dress and hair have already been described with reference to braid making. The hat and sleeves may be created using the first edible composition applied to colored wafer paper and attached with edible glue. The collar may be formed using about a 50:50 ratio of the first edible composition and confectionary coating. The mixture is spread on a large circle on a silicone mat to form an edible fabric, which is gathered and pleated. The pleats are held together with edible glue. The collar may be formed around a jar until dried.

In another example embodiment, the edible composition may be used to form sheets of edible paper.

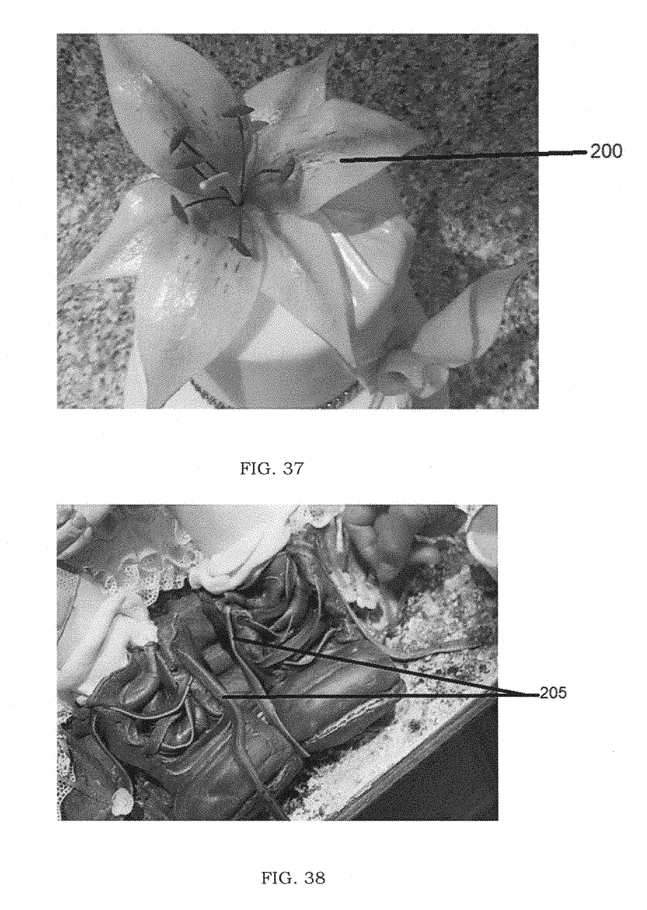

FIG. 37 is an illustration of an edible lily made from an edible composition according to at least one example embodiment.

In at least one example embodiment, as shown in FIG. 37, an edible lily 200 may be formed from the edible composition according to at least one example embodiment.

In at least on example embodiment, the first and/or second edible compositions of Examples 1 and 2 may be used to form the edible lily 200. The resulting lily 200 may be pliable and/or flexible when dried.

In other example embodiments, the first edible composition, alone, or mixed with one of fondant, gum paste, or confectionary coating in a ratio of about 50:50 may be used to form the lily 200. The resulting lily 200 may be less pliable and/or flexible when dried if the edible composition is mixed with one of fondant, gum paste, or confectionary coating, and the lily 200 may harden once dried. The lily 200 should not be brittle or prone to breaks.

FIG. 38 is an illustration of edible shoelaces made from an edible composition according to at least one example embodiment.

In at least one example embodiment, as shown in FIG. 38, edible shoelaces 205 may be formed from the edible composition according to at least one example embodiment by either spreading it out on a mat and cutting strips or by extruding. If desired, the edible shoelaces 205 may be laced into shoes because the shoelaces 205 maintain flexibility, pliability, and/or should not break during tying and wear.

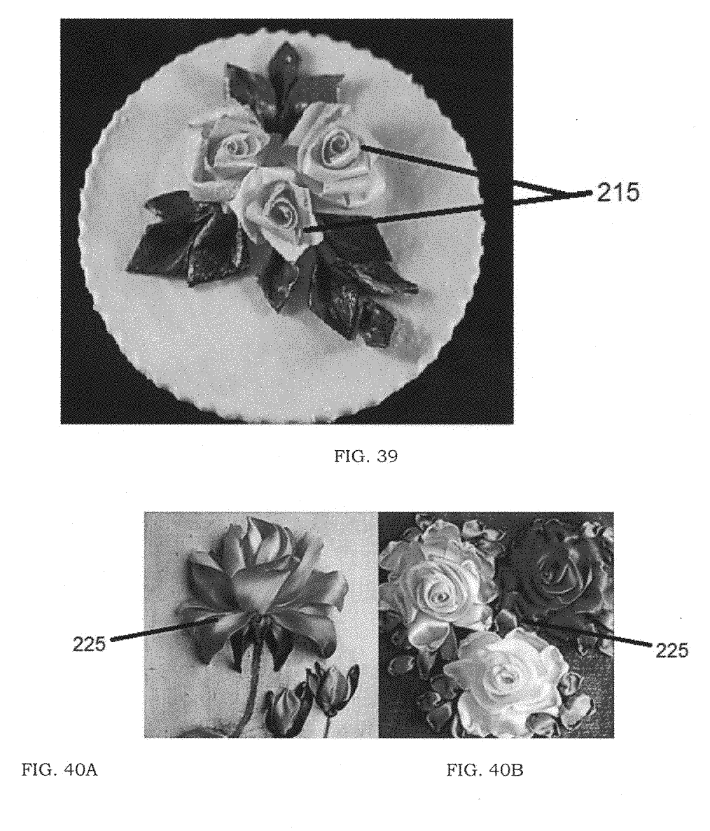

FIG. 39 is an illustration of edible ribbon roses made from an edible composition according to at least one example embodiment.

In at least one example embodiment, as shown in FIG. 39, ribbon roses 215 may be formed from the edible composition according to at least one example embodiment.

In at least one example embodiment, the ribbon roses 215 may be formed of the first and/or second edible compositions of Examples 1 and 2.

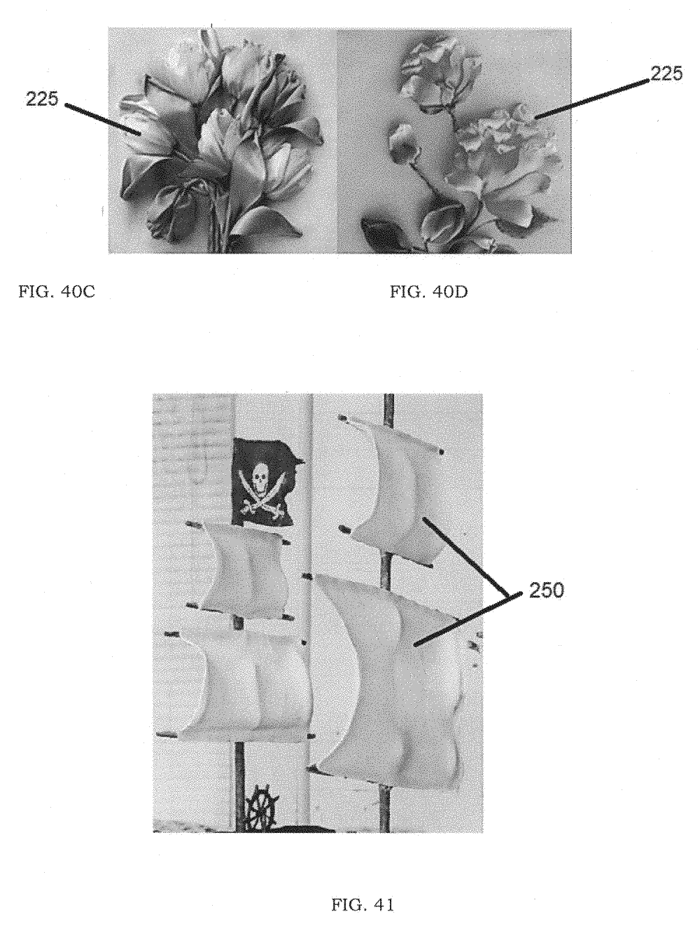

FIGS. 40A, 40B, 40C, and 40D are illustrations of edible embroidery made from an edible composition according to at least one example embodiment.

In at least one example embodiment, as shown in FIGS. 40A, 40B, 40C, and 40D, edible flower embroidery 225 may be formed from the edible composition according to at least one example embodiment.

In at least one example embodiment, the flower embroidery 225 may be formed of the first and/or second edible compositions of Examples 1 and 2.

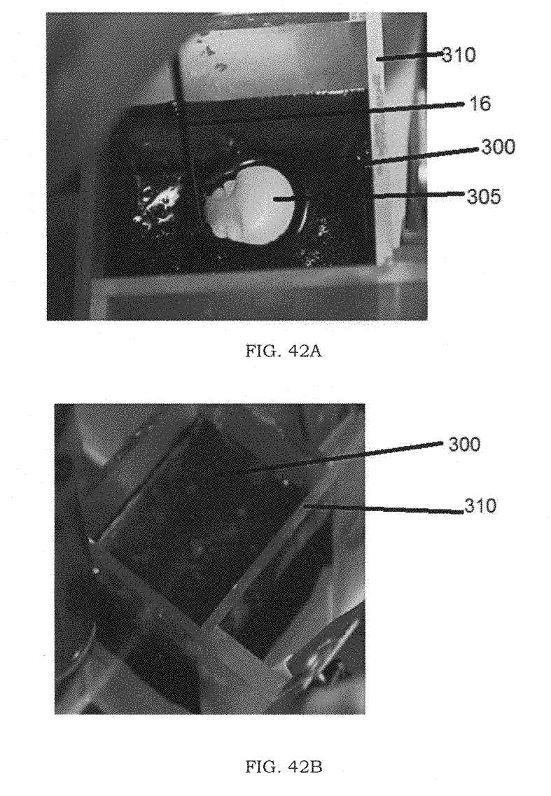

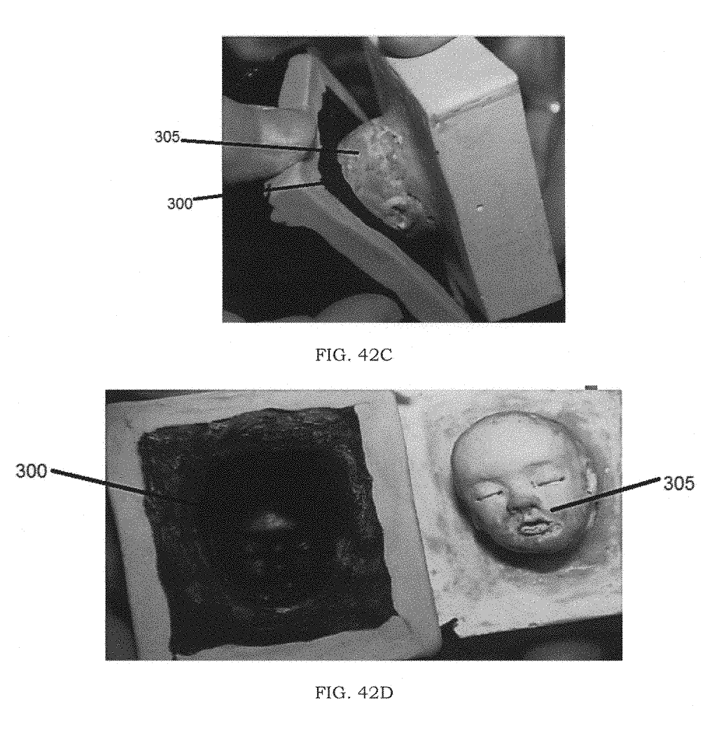

FIG. 41 is an illustration of edible ship sails made from an edible composition according to at least one example embodiment.

In at least one example embodiment, as shown in FIG. 41, edible ship sails 250 may be formed from the edible composition according to at least one example embodiment.

In at least one example embodiment, the ship sails 250 may be formed of the first, second, third, fourth, and/or fifth edible compositions of Examples 1-5.

FIGS. 42A, 42B, 42C, and 42D are illustrations of a mold being formed of an edible composition according to at least one example embodiment.

In at least one example embodiment, as shown in FIGS. 42A, 42B, 42C, and 42D, an edible composition may be used to form a mold of an object.

In at least one example embodiment, as shown in FIG. 42A, an object 305 may be placed in a container 310. The edible composition in liquid and/or semi-liquid form 16 may be poured over the object 305 and allowed to dry to form a mold 300. As shown in FIG. 42B, the edible composition 16 is allowed to dry in the container 310 to form the mold 300. As shown in FIGS. 42C and 42D, the mold 300 can be peeled or pulled off the object 305 to expose the object 305 and form the final mold 300.

In at least one example embodiment, the mold may be formed of the first, second, and/or third edible compositions so as to form a flexible and/or pliable mold 300. A mule rigid mold may be formed using the fourth edible composition of Example 4.

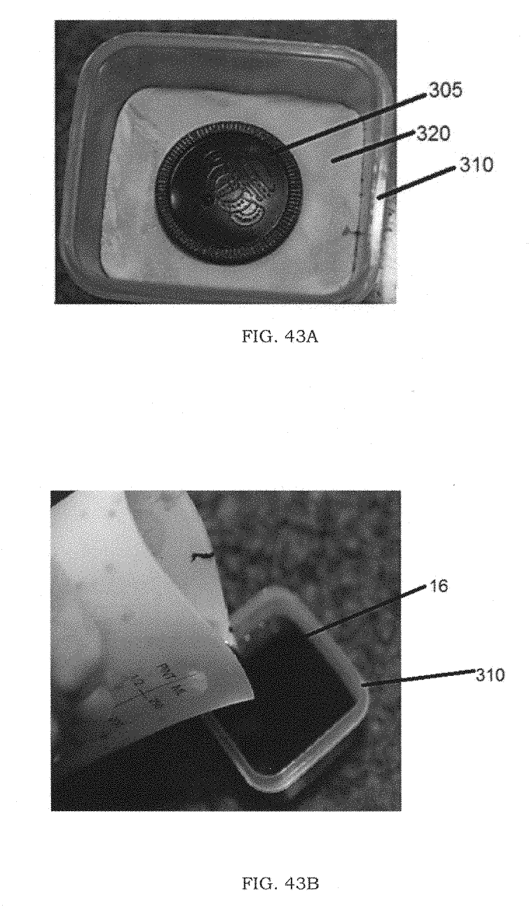

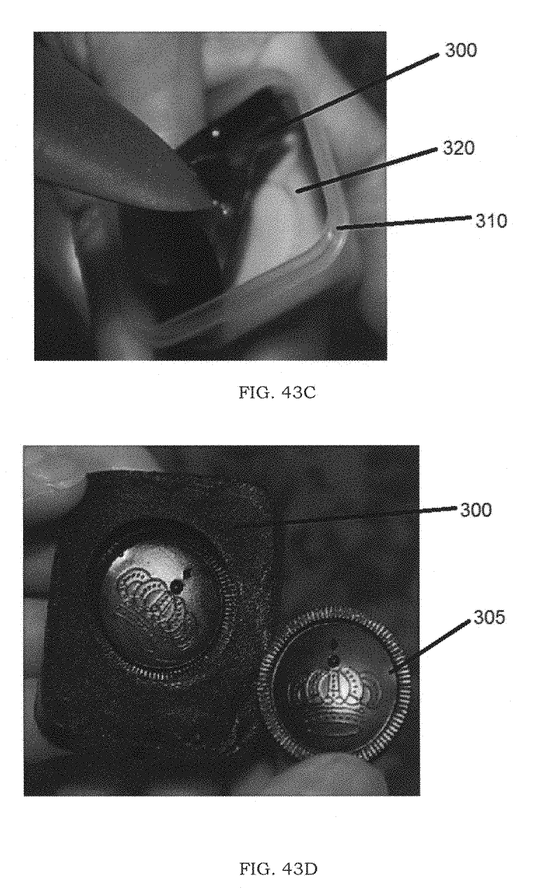

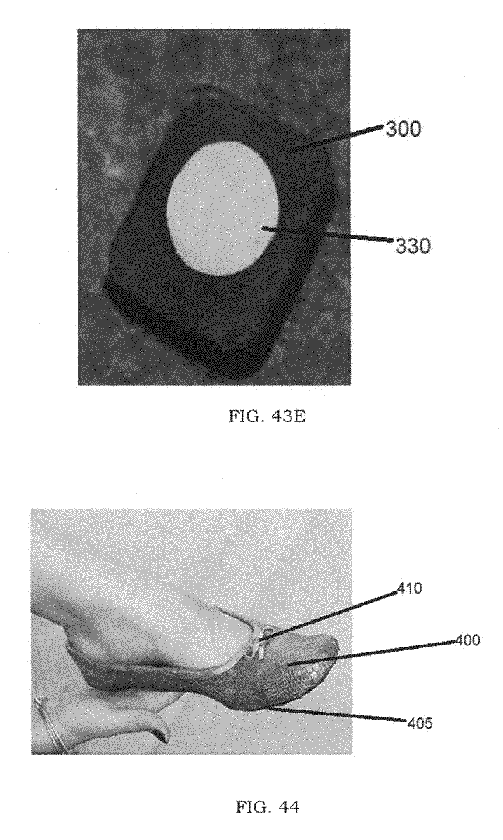

FIGS. 43A, 43B, 43C, 43D, and 43E are illustrations of a mold being formed of an edible composition according to at least one example embodiment.

In at least one example embodiment, as shown in FIGS. 43A, 43B, 43C, 43D, and 43E, a mold 300 may be formed of the edible composition. As shown in FIG. 43A, an object 305 may be anchored to an anchor substance 320, such as chocolate or any other suitable substance than may hold the object 305 in place within a container 310. As shown in FIG. 43B, the edible composition in liquid and/or semi-liquid form 16 may be poured over the object 305 in the container 310. The edible composition in liquid and/or semi-liquid form 16 may then be dried for about 5 minutes to about 36 hours. Once dried, the mold 300 is formed. The mold 300 may be removed by peeling the mold 300 away from the container 310 and anchor substance 320. The mold 300 may be flexible and/or pliable. The mold 300 may have a sufficient tensile strength to avoid and/or reduce breakage of the mold 300. As shown in FIG. 43D, the mold 300 is substantially identical to the object 305 molded. As shown in FIG. 43E, any edible substance 330 may be poured into the mold 300 to form replicas of the molded object 305.

At least one example embodiment relates to edible shoes that may be worn.

In at least one example embodiment, as shown in FIG. 44, an edible shoe 400 may be formed of the edible compositions. As shown, the edible shoe 400 may include an edible sole 405 and edible trim 410 such as a bow. The edible compositions may be flexible, pliable, and/or stretchy and/or have sufficient tensile strength to allow a person to wear the edible shoe 400 if desired. The shoe 400 may be formed of an edible fabric that may be textured to mimic snakeskin. The edible fabric may be painted or lustered to mimic the colors of snakeskin or any other suitable color.

In at least on example embodiment, the show 400 may be formed of a fabric including layers of the first edible composition and wafer paper.

In other example embodiments, the edible fabrics and/or sheets described herein may be used to form swags on cakes and/or other edible products. The swags may look substantially like real fabrics.

In at least one example embodiment, the first edible composition of Example 1 may be combined with pastillage. Pastillage normally dries hard in about a few minutes to about a few hours. However, when mixed in about a 50:50 ratio with the first edible composition, the resulting composition stays flexible much longer before hardening. For example, the mixture may maintain flexibility for up to about 4 days (e.g., up to about 3 days, up to about 2 days, or up to about 1 day). Thus, the mixture may be manipulated and used for decorating over a longer period of time, which may enable a baker longer time to decorate and/or form edible objects than when using pastillage alone.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

We claim:

1. An edible composition, comprising:
thickening agent in an amount ranging from about 8% by weight based on a weight of the edible composition to about 35% by weight based on the weight of the edible composition;
sweetener in an amount ranging from about 1% by weight based on the weight of the edible composition to about 9% by weight based on the weight of the edible composition;
humectant in an amount ranging from about 10% by weight based on the weight of the edible composition to about 75% by weight based on the weight of the edible composition; and
preservative in an amount ranging from about 0% by weight based on the weight of the edible composition to about 0.1% by weight based on the weight of the edible composition.

2. The composition of claim 1, further comprising:
water in an amount ranging from about 30% by weight based on the weight of the edible composition to about 65% by weight based on the weight of the edible composition.

3. The composition of claim 1, wherein the thickening agent comprises at least one of gelatin, agar agar, or collagen hydrosolate.

4. The composition of claim 3, wherein the sweetener is an artificial sweetener.

5. The composition of claim 4, wherein the artificial sweetener comprises at least one of stevia leaf extract, saccharin, aspartame, sucralose, xylitol, inulin, dextrose, isomalt, maltodextrin, acesulfame potassium, mogrosides, or erythritol.

6. The composition of claim 1, wherein the sweetener comprises sucrose.

7. The composition of claim 1, wherein the humectant comprises at least one of vegetable based glycerin, animal based glycerin, or synthetic glycerin.

8. The composition of claim 1, wherein the sweetener comprises at least one of corn syrup, maple syrup, light, dark or high fructose corn syrup, glucose syrup, agave nectar, or honey.

9. The composition of claim 1, wherein the preservative comprises at least one of potassium sorbate or citric acid.

10. The composition of claim 1, further comprising:
an additive.

11. The composition of claim 10, wherein the additive comprises one or more of flavorants, colorants, or aromatics.

12. The composition of claim 1, wherein the edible composition has a shelf life of at least about 1 month.

13. The composition of claim 12, wherein the shelf life ranges from about 1 month to about 1 year.

14. The composition of claim 1, wherein the edible composition has an elongation at break of up to about 275%.

15. The composition of claim 1, wherein the edible composition has a tensile strength ranging from about 0.001 psi to about 0.01 psi.

16. An edible decorative article, comprising:
an edible composition including,
thickening agent in an amount ranging from about 8% by weight based on the weight of the edible composition to about 35% by weight based on the weight of the edible composition,
sweetener in an amount ranging from about 1% by weight based on the weight of the edible composition to about 9% by weight based on the weight of the edible composition,
humectant in an amount ranging from about 10% by weight based on the weight of the edible composition to about 75% by weight based on the weight of the edible composition,
preservative in an amount ranging from about 0% by weight based on the weight of the edible composition to about 0.1% by weight based on the weight of the edible composition,
water in an amount ranging from about 30% by weight based on the weight of the edible composition to about 65% by weight based on the weight of the edible composition, and
at least one additive.

17. The article of claim 16, wherein the thickening agent comprises at least one of gelatin, agar agar, or collagen hydrosolate.

18. The article of claim 16, wherein the sweetener is an artificial sweetener.

19. The article of claim 18, wherein the artificial sweetener comprises at least one of stevia leaf extract, saccharin, aspartame, sucralose, xylitol, inulin, dextrose, isomalt, maltodextrin, acesulfame potassium, mogrosides, or erythritol.

20. The article of claim 18, wherein the humectant comprises at least one of vegetable based glycerin, animal based glycerin, or synthetic glycerin.

21. The article of claim 18, wherein the sweetener comprises at least one of corn syrup, maple syrup, light, dark or high fructose corn syrup, glucose syrup, agave nectar, or honey.

22. The article of claim 16, wherein the preservative comprises at least one of potassium sorbate or citric acid.

23. The article of claim 16, wherein the additive comprises one or more of flavorants, colorants, or colorants.

24. The article of claim 16, wherein the edible, decorative article has a shelf life of at least about 1 month.

25. The article of claim 16, wherein, the edible decorative article includes at least one of a sheet, a fabric, a body paint, a glue, a sealant, a molded shape, a cut-out shape, a woven article, edible clothing, a sculpture, a printed sheet, or piped shapes.
